(19) United States
(12) Patent Application Publication
(10) Pub. No.: US 2018/0110037 A1
(43) Pub. Date: Apr. 19, 2018

(54) USER APPARATUS AND METHOD FOR TRANSMITTING CONTROL INFORMATION

(71) Applicant: NTT DOCOMO, INC., Tokyo (JP)

(72) Inventors: Shimpei Yasukawa, Tokyo (JP); Hiroki Harada, Tokyo (JP); Satoshi Nagata, Tokyo (JP); Qun Zhao, Beijing (CN)

(73) Assignee: NTT DOCOMO, INC., Tokyo (JP)

(21) Appl. No.: 15/561,401

(22) PCT Filed: Mar. 29, 2016
(86) PCT No.: PCT/JP2016/060241

§ 371 Date: Sep. 25, 2017

(30) Foreign Application Priority Data
Mar. 31, 2015 (JP) 2015-074184

(51) Int. Cl. H04W 72/04; H04W 92/18

(52) U.S. Cl. CPC H04W 72/0406; H04W 88/04; H04W 76/023; H04W 92/18

(57) ABSTRACT

A user apparatus used in a mobile communication system supporting D2D communication includes a broadcast channel information transmitter configured to transmit configuration information of a resource for another user apparatus to receive D2D control information, and information representing that the D2D control information is to be transmitted by using a broadcast channel for D2D; and a control information transmitter configured to transmit the D2D control information by using the resource.

### TECHNICAL FIELD

The present invention relates to D2D communication (communication between user apparatuses), especially, relates to a method for transmitting control information in D2D communication.

### BACKGROUND ART

In a mobile communication system such as the LTE, it is common that communication between user apparatuses UE is executed through a base station eNB and the like by executing communication between the base station eNB and the user apparatuses UE. However, in recent years, various technologies have been proposed about the D2D communication in which communication is executed directly between user apparatuses (referred to as “D2D”, below).

It has been proposed, especially for D2D in LTE, “Communication” in which data communication such as push calls are executed between user apparatuses UE, and “Discovery” in which a user apparatus UE transmits a “discovery message” including an application ID and the like, to make a user apparatus UE on the receiving side detect the user apparatus UE on the transmitting side (see, for example, Non-patent document 1).

In D2D specified in LTE, a user apparatus UE uses a part of uplink resources that have been already specified as resources of uplink transmission of signals from a user apparatus UE to a base station eNB. In the following, the transmission of signals of D2D in the LTE will be summarized.

As for “Discovery,” as illustrated in FIG. 1A, for each Discovery period, a resource pool for the discovery message is secured, and a user apparatus UE transmits a discovery message in the resource pool. More specifically, there are Type 1 and Type 2b. In Type 1, a user apparatus UE selects a transmission resource in the resource pool autonomously. In Type 2b, a semi-static resource is allocated by upper layer signaling (e.g., an RRC signal).

As for “Communication,” as illustrated in FIG. 1B, resource pools for the control/data transmission are secured periodically. A user apparatus on the transmitting side indicates resources for the data transmission and the like to the receiving side by SCI (Sidelink Control Information) by using a resource selected in the control resource pool, and transmits the data by the resource for the data transmission. In “Communication”, there are Mode 1 and Mode 2 more specifically. In Mode 1, a resource is allocated dynamically by (E) PDCCH sent from a base station eNB to a user apparatus UE. In Mode 2, a user apparatus UE selects a transmission resource in the resource pools for control/data transmission autonomously. A resource pool to be used is indicated by SIB or defined in advance.

In LTE, a channel used for “Discovery” is referred to as a PSDCH (Physical Sidelink Discovery Channel), a channel to transmit control information such as SCI in “Communication” is referred to as a PSCCH (Physical Sidelink Control Channel), and a channel to transmit data is referred to as a PSSCH (Physical Sidelink Shared Channel) (Non-patent document 2).

### RELATED ART DOCUMENT

### Non-Patent Document

NON-PATENT DOCUMENT 1: 3GPP TR 36.843 V12.0.1 (2014-03)
NON-PATENT DOCUMENT 2: 3GPP TS 36.213 V12.4.0 (2014-12)
NON-PATENT DOCUMENT 3: 3GPP TS 23.303 V12.3.0 (2014-12)
NON-PATENT DOCUMENT 4: 3GPP TS 24.334 V12.1.1 (2015-01)

### SUMMARY OF THE INVENTION

### Problem to be Solved by the Invention

In D2D communication, if a user apparatus UE is in the coverage of a base station eNB, the user apparatus UE can execute D2D communication based on a D2D resource configuration information and the like received from the base station eNB, at timing synchronized with a synchronization signal from the base station eNB.

On the other hand, for a user apparatus UE existing out of the coverage, a technology has been proposed that makes it possible for the user apparatus UE to execute D2D communication autonomously by using pre-configured information in the apparatus, and in addition, to operate synchronized with the UE in the coverage by relaying a synchronization signal. In other words, in an example illustrated in FIG. 2, a user apparatus UE 1 in the coverage transmits a synchronization signal to a user apparatus UE 2 out of the coverage based on a synchronization signal received from the base station eNB. Furthermore, a synchronization signal can be also transmitted from the UE 2 to a UE 3.

Similar to the relay of the synchronization signal described above, relay has been also proposed for data as “ProSe UE-to-Network Relay” (non-patent document 3). In “ProSe UE-to-Network Relay”, it has been proposed that a relay UE in the coverage relays UL/DL unicast traffic between a remote UE out of the coverage and the network.

A UE out of the coverage cannot receive control information such as system information (MIB/SIB) and the like from the base station eNB. Therefore, it has been proposed for the relay of the synchronization signal described above, by using a PSBCH (Physical Sidelink Broadcast Channel), a frame number, a system bandwidth, resource configuration information, and the like are indicated from a UE in the coverage to the UE out of the coverage.

However, if executing the relay of data, the remote UE needs to transmit and receive various D2D signals with the UE in the coverage for measurement for selecting relay UE, allocation of the IP address, and the like, and to do so, needs to grasp control information such as the configuration of the D2D resources. However, since the information capacity that can be included in the PSBCH as control information is small (e.g., 19 bits), there may be cases where such control information cannot be transmitted by PSBCH. The problem that the small capacity of PSBCH makes it impossible to transmit the control information not only occurs with the relay, but also may occur in D2D communication in general.

The present invention has been developed in view of the above, and has an object to provide a technology in D2D communication that makes it possible to transmit and receive the control information between user apparatuses effectively.

### Means for Solving the Problem

According to an embodiment of the present invention, a user apparatus used in a mobile communication system supporting D2D communication is provided that includes a broadcast channel information transmitter configured to transmit configuration information of a resource for another user apparatus to receive D2D control information; and information representing that the D2D control information is to be transmitted by using a broadcast channel for D2D; and a control information transmitter configured to transmit the D2D control information by using the resource.

Also, according to another embodiment, a method for transmitting control information, executed by a user apparatus used in a mobile communication system supporting D2D communication, is provided that includes a step of transmitting broadcast channel information for transmitting configuration information of a resource for another user apparatus to receive D2D control information; and information representing that the D2D control information is to be transmitted by using a broadcast channel for D2D, and a step of transmitting control information for transmitting the D2D control information by using the resource.

### Effect of the Present Invention

A technology is provided that makes it possible to transmit and receive the control information between user apparatuses effectively in D2D communication.

### BRIEF DESCRIPTION OF THE DRAWINGS

FIG. 1A is a diagram for illustrating D2D communication;

FIG. 1B is a diagram for illustrating D2D communication;

FIG. 2 is a diagram illustrating synchronizing relay;

FIG. 3 is a configuration diagram of a communication system according to an embodiment of the present invention;

FIG. 4 is a configuration diagram of a communication system according to an embodiment of the present invention;

FIG. 5A is a diagram for illustrating an example of a channel structure used in D2D communication;

FIG. 5B is a diagram for illustrating an example of a channel structure used in D2D communication;

FIG. 6A is a diagram illustrating an example of a structure of a PSDCH;

FIG. 6B is a diagram illustrating an example of a structure of a PSDCH;

FIG. 7A is a diagram illustrating an example of a structure of a PSCCH and a PSSCH;

FIG. 7B is a diagram illustrating an example of a structure of a PSCCH and a PSSCH;

FIG. 8A is a diagram illustrating a resource pool configuration;

FIG. 8B is a diagram illustrating a resource pool configuration;

FIG. 9A is a diagram illustrating an example of a structure of PSSS/SSSS;

FIG. 9B is a diagram illustrating an example of a structure of PSSS/SSSS;

FIG. 10 is a diagram illustrating an application example of PSSS/SSSS and PSBCH;

FIG. 11 is a diagram illustrating an example of a discovery message;

FIG. 12 is a diagram for illustrating a control signal according to an embodiment;

FIG. 13 is a diagram illustrating processing steps relating to D2D SIB;

FIG. 14 is a diagram for illustrating a message format of D2D SIB;

FIG. 15 is a diagram for illustrating a message format of D2D SIB;

FIG. 16 is a diagram for illustrating an example of D2D SIB multiplexed in Communication;

FIG. 17 is a diagram illustrating an example of a protocol of an IP layer relay;

FIG. 18 is a diagram for illustrating an overview of relay initialization;

FIG. 19 is a diagram illustrating an example of steps for relay initialization;

FIG. 20 is a diagram illustrating an example of steps for activating a relay candidate UE;

FIG. 21 is a diagram illustrating an example of steps including an indication of relay-enabled NW/UE;

FIG. 22 is a configuration diagram of a user apparatus UE according to an embodiment of the present invention;

FIG. 23 is a HW configuration diagram of a user apparatus UE;

FIG. 24 is a configuration diagram of a base station according to an embodiment of the present invention; and

FIG. 25 is a HW configuration diagram of a base station.

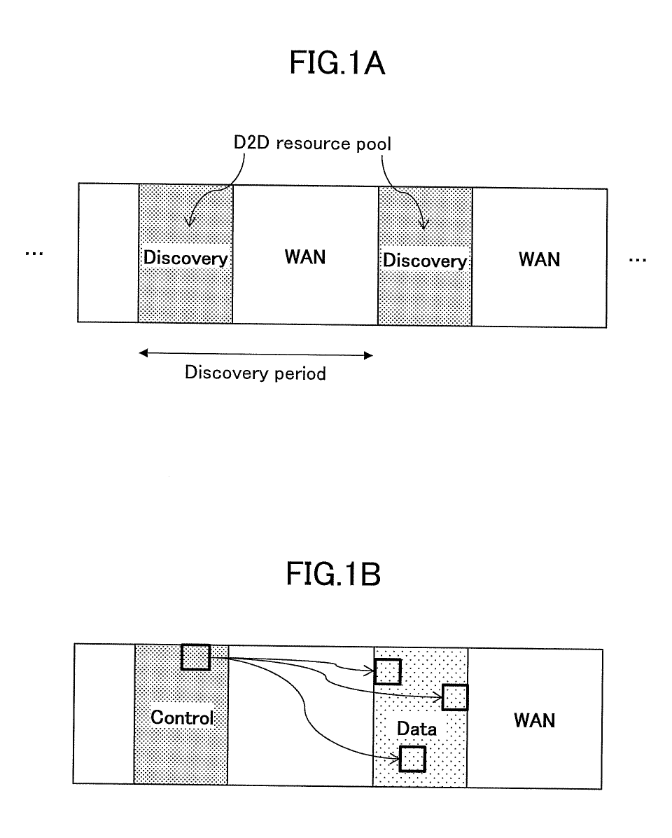

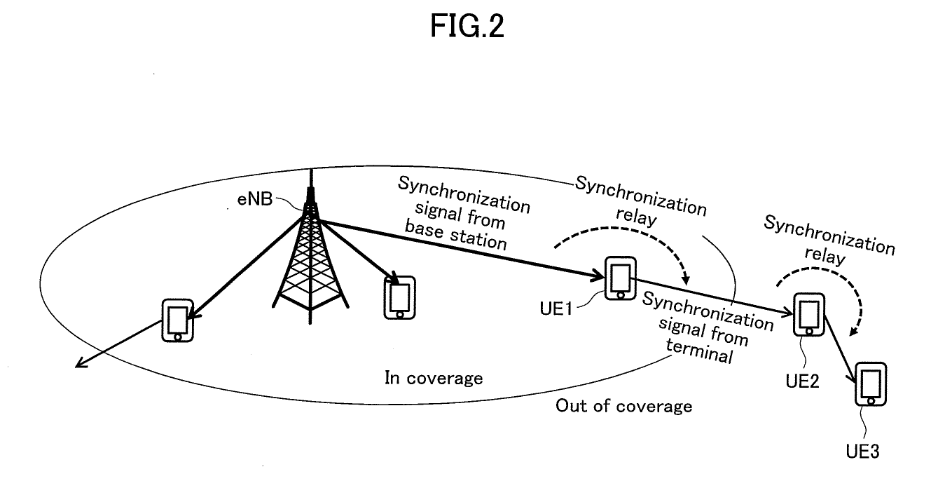

### EMBODIMENTS FOR CARRYING OUT THE INVENTION

In the following, embodiments of the present invention will be described with reference to the drawings. Note that the embodiments described below are just examples, and embodiments to which the present invention can be applied to are not limited to the following embodiments. For example, a mobile communication system according to the embodiment assumes types of systems compatible with LTE, but the present invention is not limited to LTE but applicable to other types. Also, in the present specification and claims, “LTE” is used in a broad meaning that includes communication schemes corresponding to Releases 12, 13, and after in 3GPP.

In the following, in principle, “eNB” represents a base station and “UE” represents a user apparatus. “eNB” is an abbreviation of an “evolved node B”, and “UE” is an abbreviation of “user equipment”.

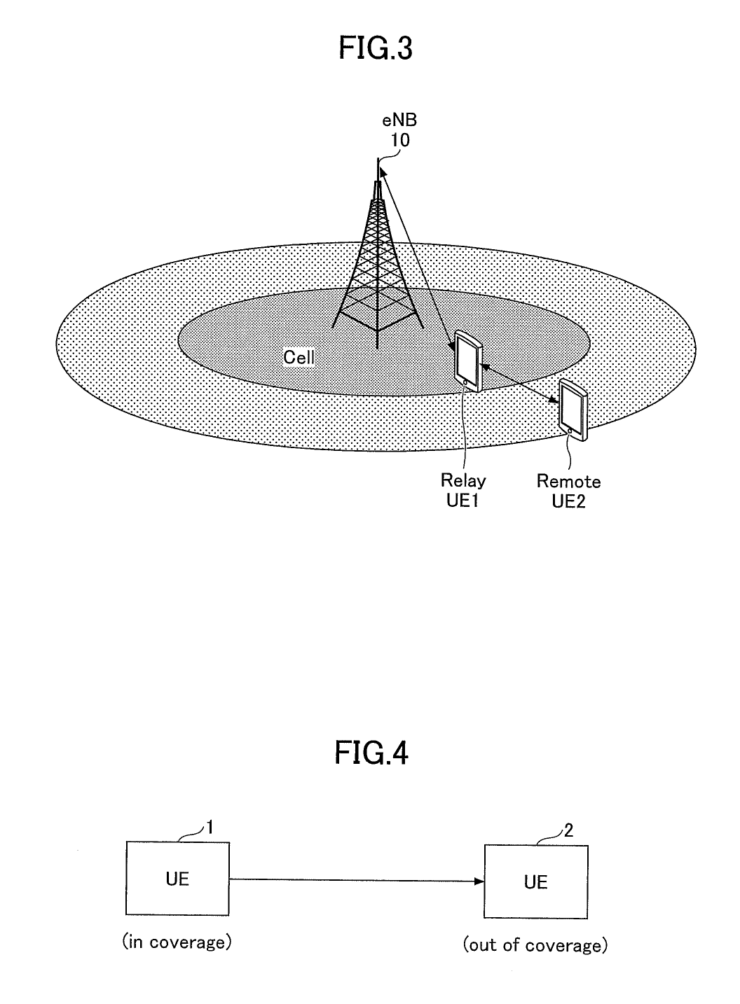

(System configuration) FIG. 3 is configuration diagram of a communication system according to an embodiment of the present invention. The communication system according to the embodiment is a cellular communication system in which a UE 1 exists in the coverage (cell) of an eNB 10. The UE 1 in the coverage has D2D communication functions, and can execute D2D communication with another UE in the coverage. Also, the UE 1 in the coverage can execute D2D communication with a UE 2 out of the coverage. The UE 2 out of the coverage also has the D2D communication functions, and can execute D2D communication with another UE. Furthermore, the UE 1 in the coverage can execute normal cellular communication with the eNB 10.

The UE 1 in the coverage has a signal relay function, and may be referred to as the “relay UE 1”. Also, the UE 2 out of the coverage may be referred to as the “remote UE 2”. The relay UE 1 can relay a signal between the eNB 10 and the remote UE 2. Note that being capable of relaying is just an example.

A link between the eNB 10 and the relay UE 1 is referred to as a “backhaul link”, and a link between the relay UE 1 and the remote UE 2 is referred to as an “access link”.

The configuration of the relay illustrated in FIG. 3 is just an example of an application of the present invention, and the present invention is applicable to other than the relay and the like. In other words, the present invention is generally applicable to a communication system that executes D2D communication between the UE 1 in the coverage and the UE 2 out of the coverage, for example, as illustrated in FIG. 4. This includes both transmitting D2D control information and the like from the UE 1 in the coverage to the UE 2 out of the coverage, and transmitting D2D control information and the like from the UE 2 out of the coverage to the UE 1 in the coverage. Also, a system including the UE 1 and the UE 2 illustrated in FIG. 4 may be out of the coverage as a whole, or may be in the coverage as a whole.

In the embodiment, technologies will be described in detail that implement effective transmission and reception of control information in such a communication system. Before describing the technologies, an example of D2D technology will be described as the basis.

(Structure of Channel Used in D2D Communication)

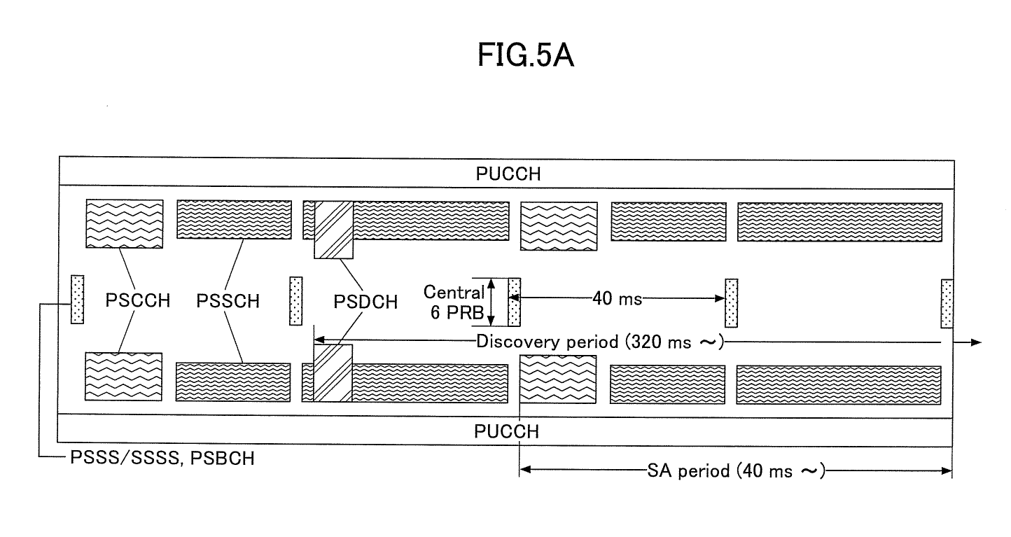

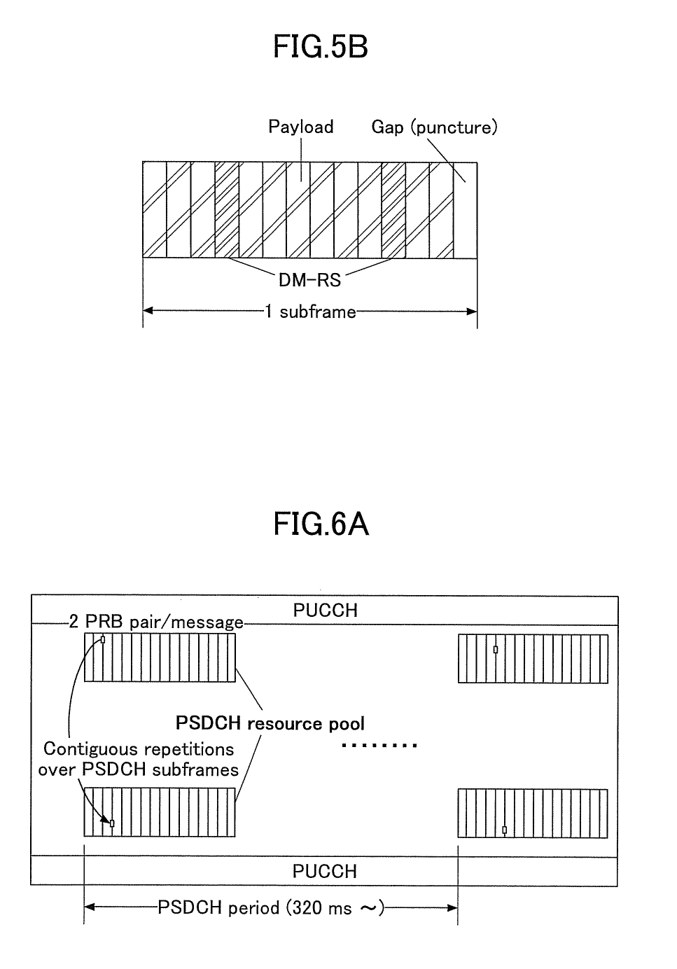

Transmission and reception of a signal in D2D communication are executed using a part of the resources of the uplink in cellular communication. Examples of the channel structure of the D2D communication are illustrated in FIGS. 5A-5B. A resource pool of the PSCCH and a resource pool of the PSSCH used for Communication are allocated as illustrated in FIG. 5A. Also, a resource pool of the PSDCH used for Discovery is allocated in a period longer than the period of the channel for Communication.

Also, PSSS (Primary Sidelink Synchronization SIGNAL) and SSSS (Secondary Sidelink Synchronization SIGNAL) are used as synchronization signals for D2D. Also, for operations out of the coverage, a PSBCH (Physical Sidelink Broadcast Channel) is used for transmitting a system band, a frame number, and broadcast information such as resource configuration information of D2D. FIG. 5B is example of a structure of the PSCCH and PSSCH.

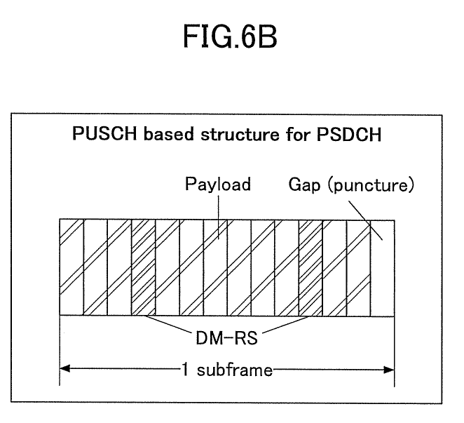

FIG. 6A illustrates an example of the resource pool of PSDCH used for Discovery. Since the resource pool is set by a bitmap of subframes, the resource pool may have an image as illustrated in FIG. 6A. Resource pools of other channels are virtually the same. Also, through the PSDCH, repeated transmission (repetition) is executed with frequency hopping. Repetition counts may be set to, for example, 0 to 4. Also, as illustrated in FIG. 6B, the PSDCH has a PUSCH-based structure, in which DM-RS is inserted.

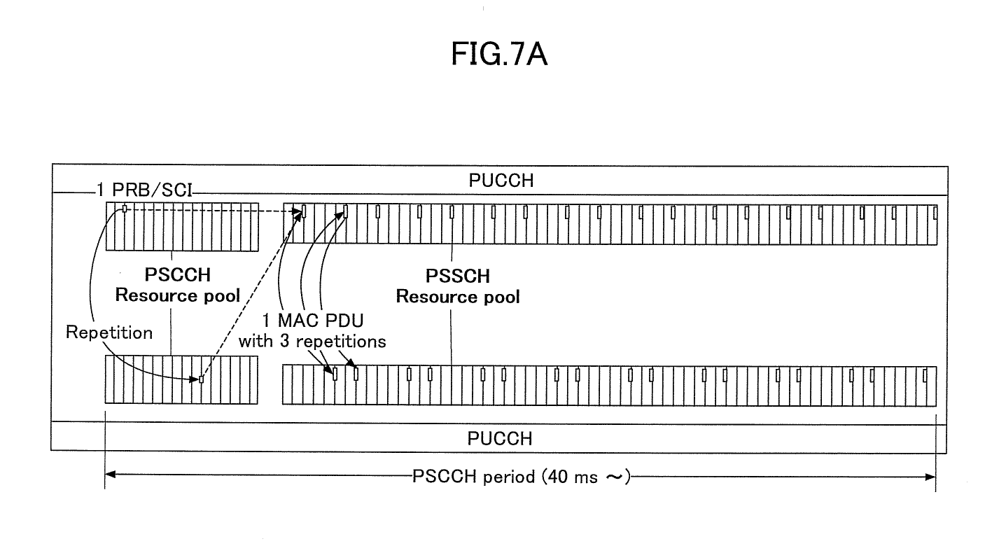

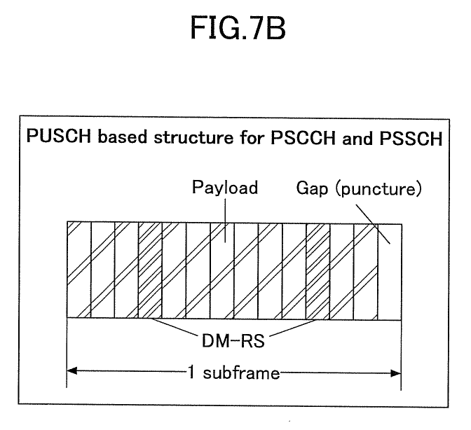

FIG. 7A illustrates an example of resource pools of the PSCCH and PSSCH used for Communication. As illustrated in FIG. 7A, through the PSCCH, repeated transmission (repetition) is executed once while doing frequency hopping. Through the PSSCH, repeated transmission (repetition) is executed three times while doing frequency hopping. Also, as illustrated in FIG. 7B, the PSCCH and PSSCH have PUSCH-based structures in which DM-RS is inserted.

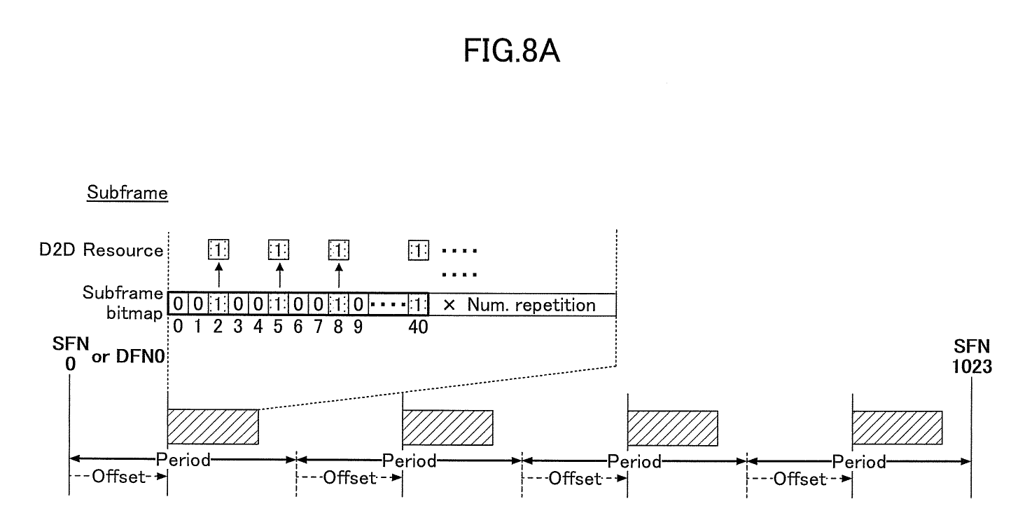

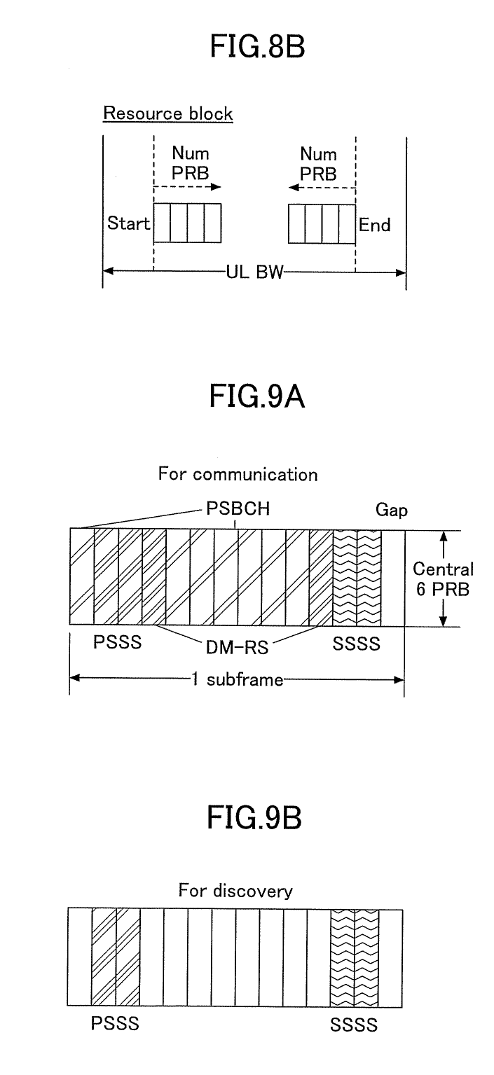

FIGS. 8A-8B illustrate an example of a resource pool configuration in the PSCCH, PSDCH, and PSSCH (Mode 2). As illustrated in FIG. 8A, in the time direction, the resource pool is represented as a subframe bitmap. Also, the bitmap is repeated the number of times represented by “Num.reprtition”. Also, an “Offset” is specified to designate the start position in each period.

In the frequency direction, contiguous allocation and non-contiguous allocation are possible. FIG. 8B illustrates an example of the non-contiguous allocation, and as illustrated in the figure, a start PRB, an end PRB, and the number of PRBs (NumPRB) are specified.

FIGS. 9A-9B illustrate the PSSS/SSSS. FIG. 9A, illustrates an example of a synchronizing subframe in Communication. As illustrated in the figure, the PSSS, SSSS, DM-RS, and PSBCH are multiplexed. FIG. 9B illustrates an example of a synchronizing subframe in Discovery. As illustrated in the figure, the PSSS and SSSS are multiplexed.

The PSBCH includes a DFN (D2D frame number), a TDD UL-DL configuration, an in-coverage indicator, a system bandwidth, and a reserved field.

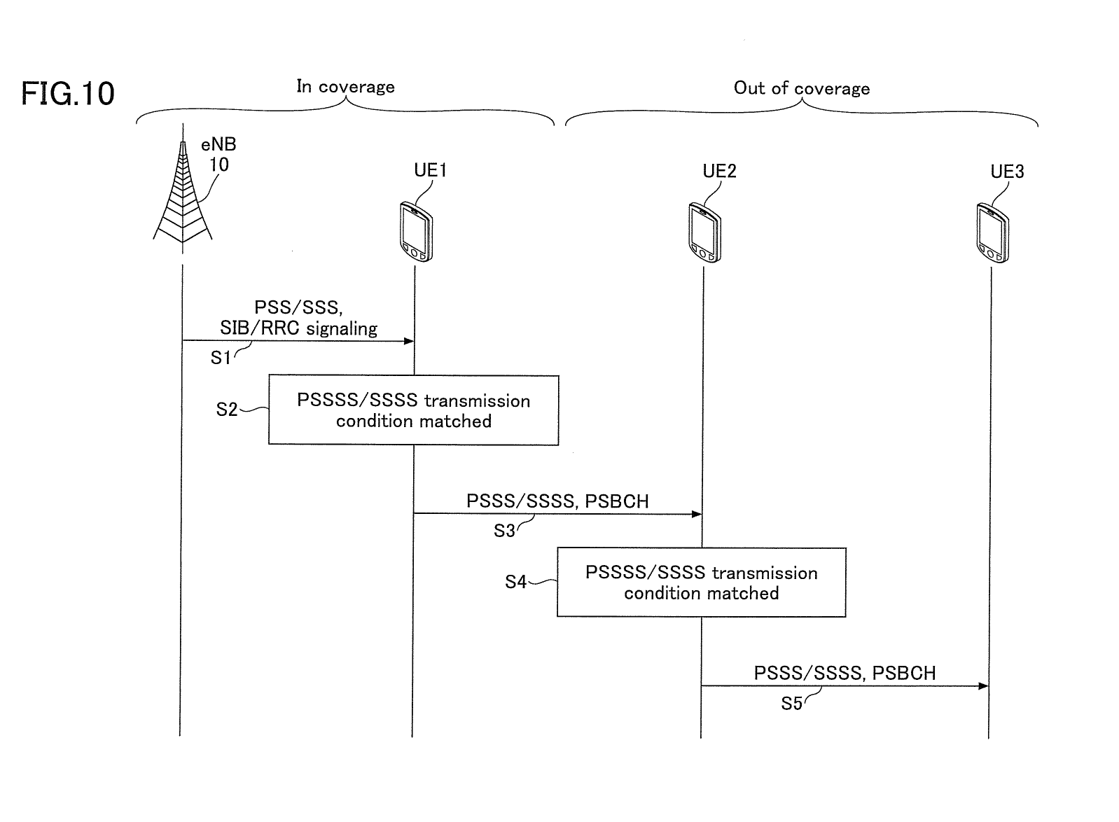

FIG. 10 illustrates an example of synchronization signal relay as a use case of the PSBCH. As illustrated in FIG. 10, the UE 1 in the coverage receives PSSS/SSSS, SIB and the like from the eNB 10 (Step S1). If a predetermined condition is satisfied, the UE 1 transmits (broadcasts) the PSSS/SSSS and PSBCH (Step S2), and the UE 2 out of the coverage receives these (Step S3). If a predetermined condition is satisfied, the UE 2 transmits (broadcasts) the PSSS/SSSS and PSBCH, and the UE 3 out of the coverage receives these (Steps S4-S5). By such a synchronizing relay, D2D communication can be executed synchronized with the cellular network, for example, between the UE 2 out of the coverage and the UE 3 out of the coverage, between the UE 1 in the coverage and the UE 2 out of the coverage, and so on.

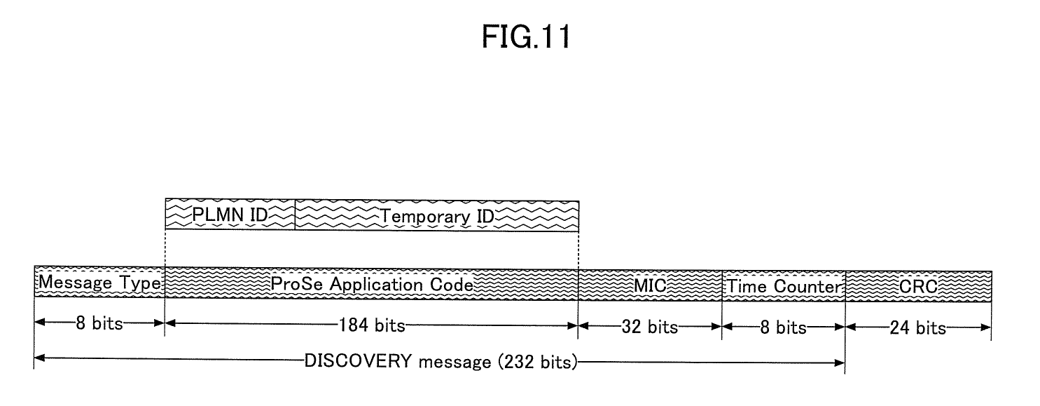

FIG. 11 illustrates content of a message for Discovery (a discovery message) transmitted by the PSDCH (Non-patent document 4). As illustrated in FIG. 11, the discovery message includes Message Type, ProSe Application Code, MIC (Message integrity check), and Time Counter, to which CRC is added. Also, the ProSe Application Code has PLMN ID and Temporary ID.

### Description of Embodiment of Present Invention

As described earlier, the payload size of the PSBCH is limited. Especially, the reserved field prepared for future expansion has only 19 bits. Therefore, for example, when executing data communication between the network and a UE out of the coverage by using a UE in the coverage as a relay, the existing PSBCH cannot indicate the resource pools of the PSDCH, PSCCH/PSSCH, and the like to execute D2D communication to the UE out of the coverage.

Thus, in the embodiment, as a basic example, a large-capacity broadcast channel is defined and used by using the channel (PSDCH) for Discovery. In the embodiment, information to be transmitted by the channel will be referred to as “D2D SIB”. This may be also referred to as “control information” or a “control signal”.

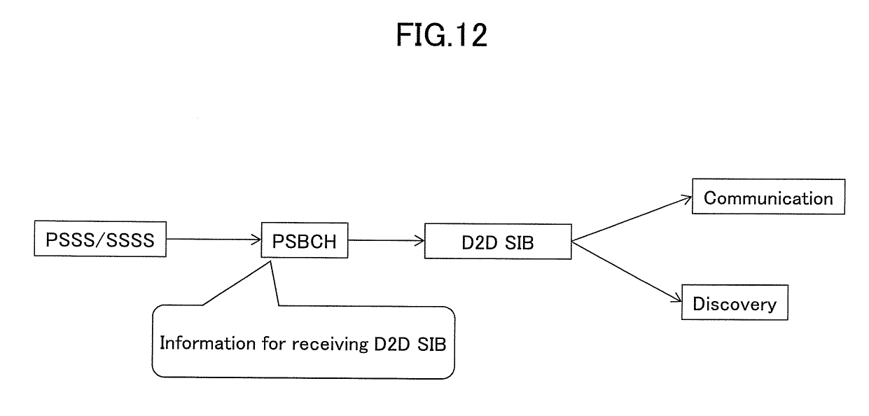

FIG. 12 is a diagram that illustrates the control signal, and describes a summary of operations of a UE receiving the D2D SIB (e.g., a UE out of the coverage). This UE receives PSSS/SSSS to be synchronized, and then, receives PSBCH. The PSBCH includes control information for receiving the D2D SIB (e.g., a resource pool configuration and the like for receiving the D2D SIB). The UE receives the D2D SIB based on the control information. The D2D SIB includes, for example, control information necessary to transmit and receive Communication/Discovery signals. The UE can transmit and receive Communication/Discovery signals based on the control information.

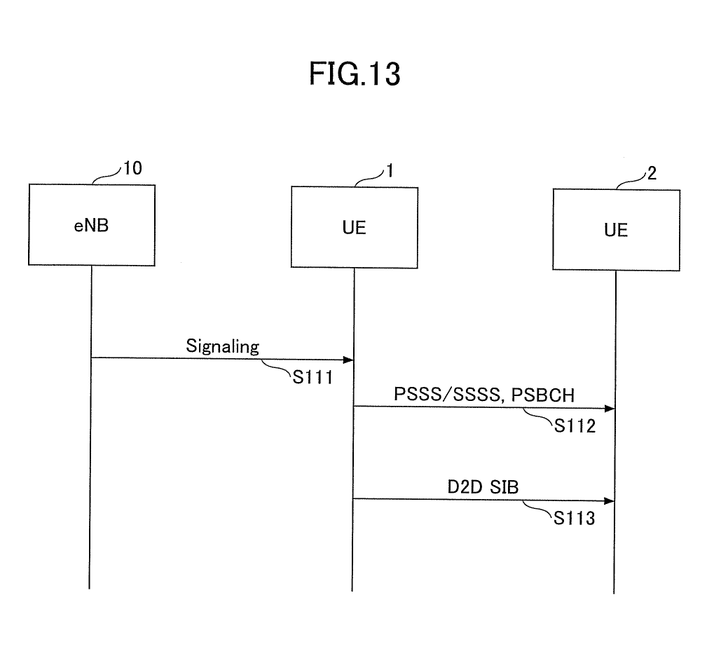

FIG. 13 is a diagram illustrating the above processing steps by a sequence chart. As illustrated in FIG. 13, the UE 1 in the coverage receives signaling from the eNB 10. The signaling includes, for example, configuration information for receiving the D2D SIB to be included in the PSBCH.

At Step S112, the UE 1 transmits the PSBCH including the information received from the eNB 10 to the UE 2 out of the coverage. At Step S113, the UE 1 transmits the D2D SIB. The UE 2 receives the D2D SIB by using the information included in the PSBCH received at Step S112, and decodes the D2D SIB to obtain the content.

Note that in the embodiment, although examples are mainly described in which the information of the resource pools and the like in the coverage is indicated to the outside of the coverage, these are just examples; the application of the present invention is not limited to indication from the inside of the coverage to the outside of the coverage. For example, it is possible to execute resource setting, transmission power control, and the like by transmitting and receiving control information between UEs in a communication group out of the coverage. It is also possible to execute resource setting, transmission power control, and the like by transmitting and receiving control information between UEs in the coverage. It is also possible to execute terminal cluster control based on the terminal positions, by limiting a UE that transmits control information out of the coverage to those UEs transmitting a synchronization signal, or those UEs that cannot detect control information from the other UE or can receive the control information but below a certain level (to set a master UE).

Also, in the embodiment, although the example is described in which the backhaul is LTE, this is also just an example; as another example, the backhaul may be a wired communication network, a satellite network, or the like.

The D2D SIB in the embodiment, may be specific to a cell (cell specific), may be specific to a UE (UE specific), may be specific to a group (group specific), or may be information in which cells or UEs are not distinguished.

The cell specific D2D SIB includes, for example, the ID and/or the SLID (Sidelink ID) of a cell in which the UE 1 in the coverage of the cell transmits the D2D SIB. Also, the ID may be detected from the PSSS/SSSS associated with the D2D SIB.

The UE specific D2D SIB, includes, for example, the ID (e.g., L2 ID) of the UE 1 in the coverage transmitting the D2D SIB. The group specific D2D SIB includes, for example, the ID to identify a group associated with the D2D SIB.

<Configuration Information for Receiving the D2D SIB>

The information about the configuration for receiving the D2D SIB transmitted by the PSBCH is included, for example, in the reserved field of the PSBCH, to be transmitted.

The information about the configuration includes at least a D2D SIB indicator representing that the D2D SIB is to be transmitted in addition to the PSBCH. The D2D SIB indicator is represented by, for example, one bit. For example, if information described below is pre-configured, the UE 2 recognizes by the indicator that D2D SIB has been received, and obtains the D2D SIB based on the pre-configured information.

Other information items in the information about the configuration for receiving the D2D SIB include a configuration of the reception resource pool, a CP length, the number of D2D SIBs, the indices of D2D SIBs, control information about SIB transmission power, and a change notification. A detection error can be detected by the change notification. The change notification is information that is indicated if a change occurs in D2D SIB that has been already transmitted, and the D2D SIB after the change is transmitted.

For example, to the UE 1 in the coverage, by upper layer signaling from the eNB 10, the information to be transmitted by the PSBCH, the information about the D2D SIB, and the like are notified. Also, the eNB 10 may set the UE 1 to transmit the D2D SIB by the upper layer signaling. In other words, in this case, the UE 1 transmits the D2D SIB only if receiving a command to transmit the D2D from the eNB 10.

Alternatively, the UE 1 in the coverage to transmit the PSSS/SSSS/PSBCH may transmit the D2D SIB with respect to a setting of the D2D SIB if the setting has been done by the eNB 10. In other words, a command is not issued by the eNB 10 whether the UE 1 transmits the D2D SIB, but if the UE 1 is to transmit PSSS/SSSS/PSBCH, and the content of the D2D SIB has been set by the eNB 10, the UE 1 transmits the D2D SIB.

Also, a UE out of the coverage and an RRC_IDLE UE may transmit D2D SIB based on a command on an upper layer.

<Configuration Example of Resource Pool for Receiving the D2D SIB>

As a configuration of the resource pool for receiving the D2D SIB, the following configuration may be used to reduce signaling overhead. In the following, each UE grasps information assumed to be fixed, and it is not necessary to transmit the information from the UE 1 to the UE 2.

First, as time domain information, the subframe offset of a discovery period is assumed to be fixed. Also, the period (discovery period) is assumed to be fixed, or the number of alternatives is reduced. For example, the period is fixed to 32 radio frames. Also, the repeat count of the PSDCH in the resource pool is fixed, or the number of alternatives is reduced. For example, the count of transmissions may be fixed to four.

Also, the content of the subframe bitmap may be fixed, or alternatives are reduced. For example, all uplink subframes during a discovery period may be assumed to be subframes for transmitting Discovery. Also, the repetition in the subframe bitmap is fixed or alternatives are reduced. For example, the repetition in the subframe bitmap is set to one (in other words, transmitting twice).

As information in the frequency domain, for example, the granularity of PRBs is set larger than in the case of one PRB. Also, signaling is executed about the configuration of contiguous PRBs. For example, the signaling may be executed only for the start PRB and the end PRB, to omit the signaling for the number of PRBs. Also, the amount of resources in the frequency direction (PRBs) may be assumed to be fixed.

Also, it may be specified that transmitting D2D SIB is executed in one of the discovery resource pools coming periodically.

As described above, limiting the configuration of the resource pool for receiving the D2D SIB can reduce the amount of information about the configuration, and hence, the configuration of the resource pool for receiving the D2D SIB can be transmitted by using the reserved field of the PSBCH.

<Message Format of D2D SIB>

As described earlier, in the embodiment, the D2D SIB is transmitted using the format based on the discovery message.

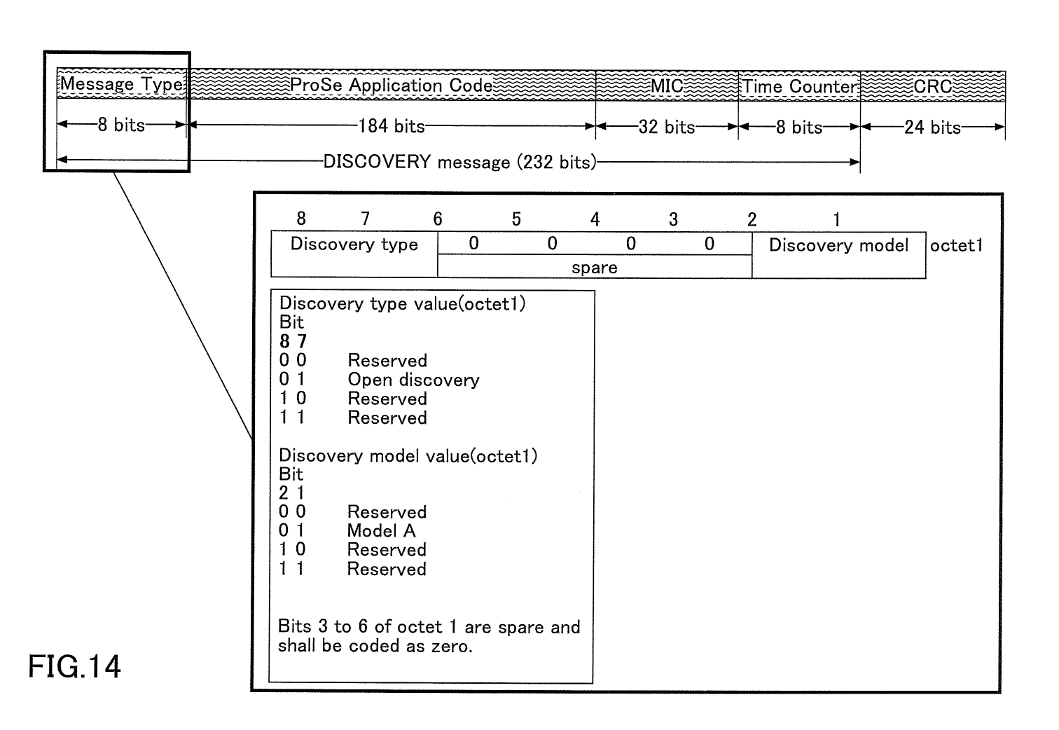

In the format, in the embodiment, a new Message Type is introduced. As illustrated in FIG. 14, since there are unused patterns among bit patterns of the Message Type (256 patterns), for example, one or more patterns among the unused patterns is used for information to identify the Type being D2D SIB. In other words, the Type is defined to distinguish that the discovery message is a message carrying D2D SIB.

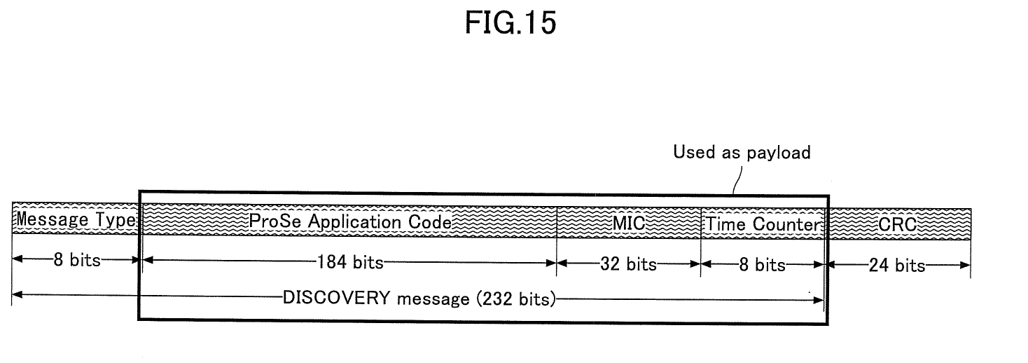

As illustrated in FIG. 15, bits other than the Message Type and CRC can be used as the payload of D2D SIB.

Especially, at least the field of ProSe Application Code can be replaced with information about D2D SIB. Also, the L2 ID or L3 ID of UE transmitting UE-specific D2D SIB is included in the UE-specific D2D SIB. The L2 ID or L3 ID to be included in the UE-specific D2D SIB may not be included in its entirety, but a part of the ID may be included. Similarly, (the entirety or a part of) the group ID may be included.

As for cell-specific D2D SIB, cell identification may be executed by the relevant PSSS/SSSS, or may be executed by including the cell ID in a predetermined field of the D2D SIB.

Also, an expiration timer may be included in the information about the D2D SIB. Providing such a timer (a timer value) makes it possible for the UE 2 out of the coverage, to avoid continuing using an old D2D SIB due to a detection error of updated D2D SIB.

Using multiple discovery messages also makes it possible to transmit multiple D2D SIBs.

In that case, each D2D SIB item has an index allocated, and, for example, the index can be included in the discovery message by using the remaining bits. Also, the information about the index may be put into the field of Message Type. Also, different resource pools coming periodically may be associated with the D2D SIBs, respectively. Also, the transmission source ID may be used as this index or a part of it. To detect missed reception, the PSBCH or a representative D2D SIB (e.g., D2D SIB 1) may include the number of D2D SIBs to be transmitted (e.g., D2D SIBs not group-specific or cell-specific).

<Multiplexing with Existing Discovery Message>

Transmitting D2D SIB common among UEs (cell-specific D2D SIB), for example, may use Type 2B resources (semi-static) allocated by the eNB 10. This makes it possible to use a resource pool that does not overlap with a resource pool used in normal Discovery, for transmitting the D2D SIB. The D2D SIB common among UEs is transmitted by the resources common among UEs. If using Type 1 (autonomous UE resource allocation), the receiving UE can detect D2D SIBs transmitted overlapping from multiple UEs by using the index information in the D2D SIBs, to filter unnecessary information. For the UE-specific D2D SIB, for example, a resource of Type 1 and Type 2B may be used.

<About Operations of UE on Receiving Side>

For example, if detecting a D2D SIB indicator in the PSBCH, the UE 2 out of the coverage uses information for receiving the D2D SIB included in PSBCH, to execute detecting the accompanying D2D SIB. If having failed in detecting the D2D SIB, for example, the UE 2 executes D2D Communication/Discovery by using the pre-configured information (pre-configuration).

### Modified Example

So far, although examples have been described in which the D2D SIB is transmitted by using Discovery, the D2D SIB may be transmitted by using Communication. In other words, the D2D SIB is transmitted by using a message of control information/data (PSCCH/PSSCH).

Even in this case, the role of PSBCH is the same as in Discovery, and the PSBCH includes a D2D SIB indicator, information of the configuration necessary for receiving control information/data, and the like. For example, the UE 2 out of the coverage uses information of the configuration included in the PSBCH received from the UE 1 in the coverage, to receive the control information/data corresponding to the D2D SIB.

In this modified example, for example, the D2D SIB is multiplexed with the normal resource pool of D2D Control/Data (the resource pool of PSCCH/PSSCH). Therefore, an ID dedicated for the D2D SIB is provided as a destination ID in “control information” and/or a “MAC header of Data”. This makes it possible for the UE on the receiving side having detected the ID to distinguish that the control information/data is of the D2D SIB.

Also, the MCS bit in the control information may be set to represent 64QAM, as an indicator of the D2D SIB. Since it is specified that 64QAM is not to be set as MCS, a receiving UE that has received the control information including the MCS can distinguish that the control information relates to the D2D SIB. The reception UE receives the D2D SIB, for example, by using a fixed MCS (e.g., QPSK).

Also, the transmission source ID in the MAC header of data may be used as a cell ID, a UE ID, or a group ID.

Also, SCI for the D2D SIB may be newly defined so that a reception terminal detects control information relating to the D2D SIB blindly.

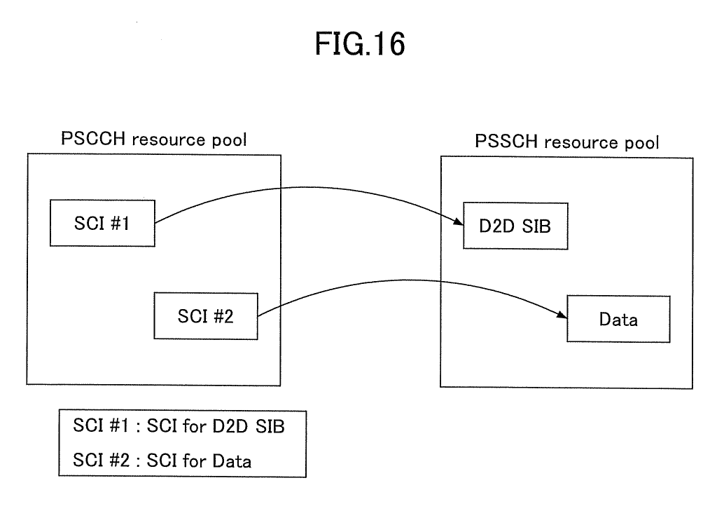

FIG. 16 illustrates an image in which the D2D SIB is multiplexed with the normal resource pool of D2D Control/Data (the resource pool of PSCCH/PSSCH). As illustrated in FIG. 16, a UE having received SCI #1 including the identification information obtains the D2D SIB. Also, a UE having received normal SCI #2 obtains the data.

Also, as another example, as the resource pool for the D2D SIB, a resource pool dedicated only for D2D SIB transmission may be defined. This makes it possible for a UE to receive the D2D SIB by the resource pool that has been pre-configured or set by broadcast information and the like.

The transmission and reception technologies of the control information (D2D SIB) according to the embodiment make it possible, for example, for a UE out of the coverage to obtain the configuration information about the resource pool in the coverage, and hence, a UE out of the coverage and a UE in the coverage can execute Communication and Discovery by using the resource pool in the coverage. Thus, uplink interference can be reduced, and interruption of D2D caused by cellular communication can be reduced.

Also, using the group-specific D2D SIB makes it possible to broadcast the control information specific to the group (a resource pool and/or transmission power and the like). Thus, better QoS can be secured.

Also, when executing the D2D relay, a relay candidate UE can transmit information about the measurement resource and the like for selecting a relay UE, to remote UE by using the D2D SIB, and hence, the D2D relay can be implemented effectively. In the following, as a specific example using the D2D SIB, this D2D relay will be described.

(General Example of Relay)

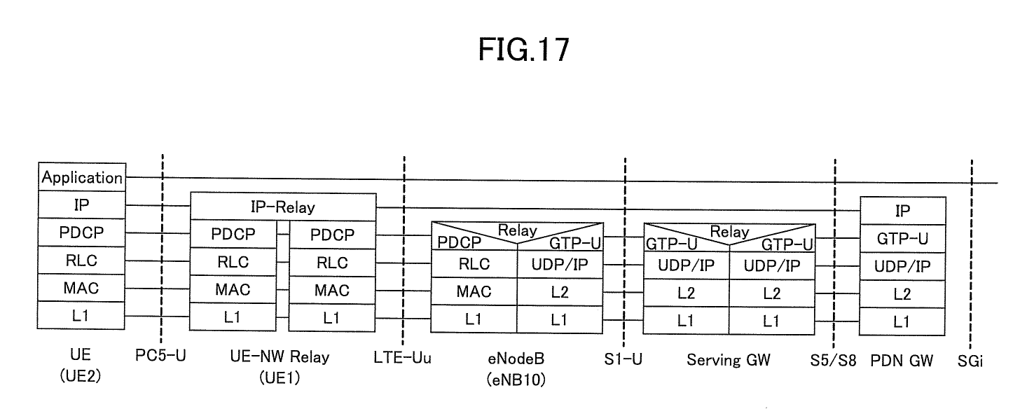

FIG. 17 illustrates an example of a protocol when executing the D2D relay. In the example illustrated in FIG. 17, the relay is executed on the IP layer. In the embodiment, as illustrated in FIG. 17, the relay is assumed to be executed on the IP layer, but the relay is not limited to be executed on the IP layer; the relay may be executed on a lower layer than the IP layer.

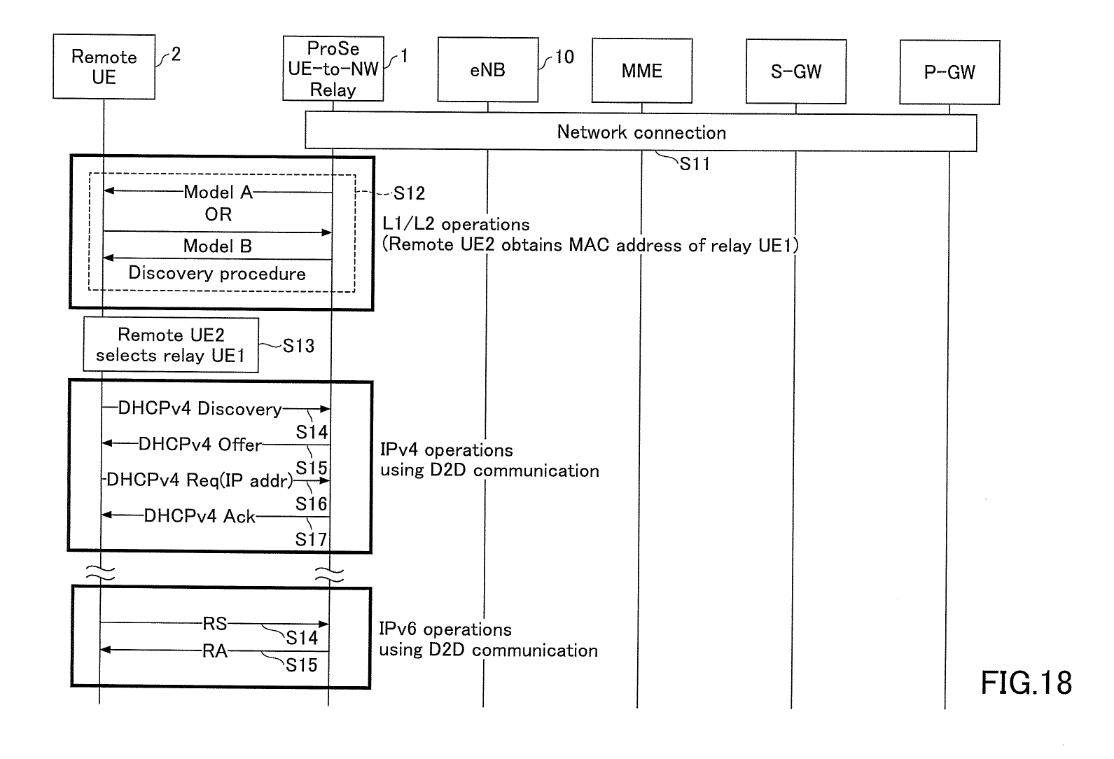

FIG. 18 is a diagram illustrating an example of a process for relay initialization that is executed to start relay communication by the protocol as illustrated in FIG. 17 (Non-patent document 3). Note that FIG. 18 is a diagram illustrating an example of a process for relay initialization (IP address allocation and the like) based on the technology described in Non-patent document 3, to facilitate understanding the content of the process according to the embodiment of the present invention.

At Step S11, the relay UE 1 establishes a connection to a network (PDN: a packet data network) to obtain information about the IP address. A discovery procedure is performed at Step S12. Here, the relay UE 1 provides information to support the remote UE 2 for selecting the relay UE 1. Note that Model A illustrated in FIG. 18 is a discovery method including announcement (on the transmitting side) and monitoring (on the receiving side), and Model B is a discovery method including a request and a response. At Step S12, as L1/L2 operations, a process is executed in which the remote UE 2 obtains the MAC address (may be referred to as the L2 address or the L2 ID) of the relay UE 1.

At Step S13, the remote UE 2 selects the relay UE 1. If the IP address on the connecting PDN is based on IPv4, the remote UE 2 specifies the L2 address and executes a procedure of DHCPv4 to obtain an IP address (Steps S14-S17).

If the IP address on the connecting PDN is based on IPv6, the remote UE 2 transmits an RS (Router Solicitation) message to the relay UE 1 (to the L2 address) (Step S14). The relay UE 1 having received the RS message transmits an RA (Router Advertisement) message including the IPv6 prefix to the remote UE 2 (Step S15).

(Example of Steps for Relay Initialization According to Embodiment)

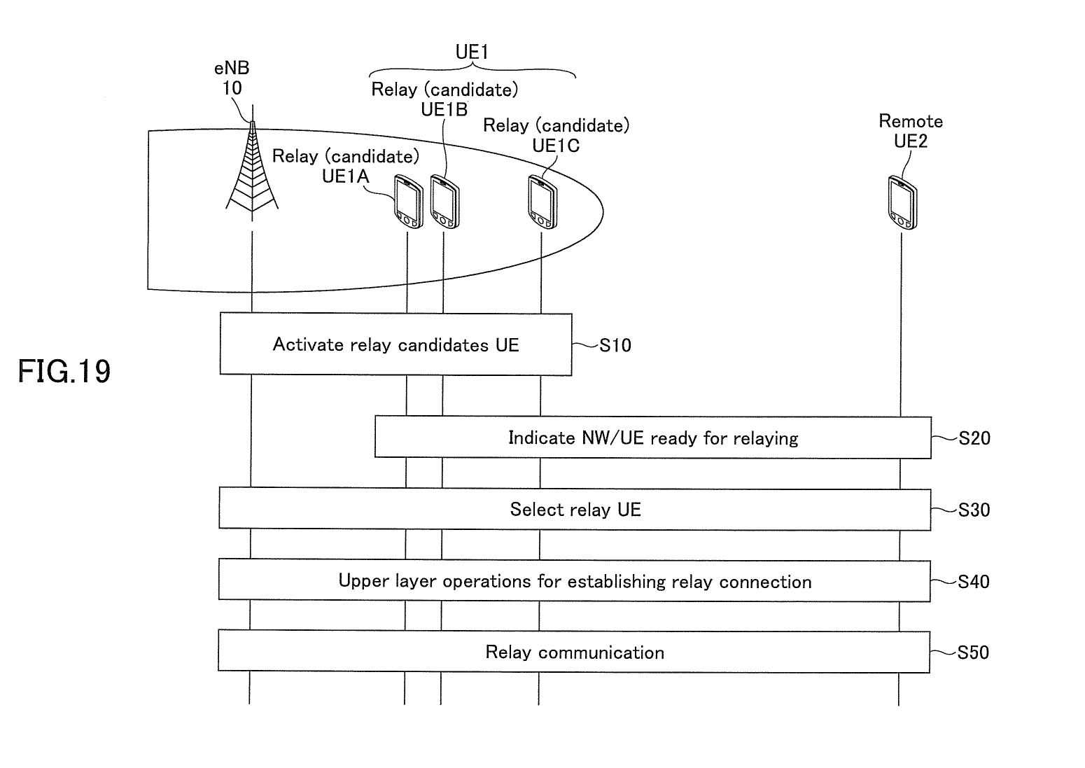

FIG. 19 is a diagram illustrating an example of steps for relay initialization (a process for starting relay communication) according to the embodiment. A summary of the steps will be described with reference to FIG. 19, and in more detail later. The configuration of a communication system in the example in FIG. 19 is substantially the same as that illustrated in FIG. 3, but multiple UEs exist in the coverage in the example in FIG. 19, each of which possibly serves as the relay UE. These are designated by the UE 1A, the UE 1B, and the UE 10. In the following, if distinguishing UEs 1A-1C is not required particularly, it will be referred to as the UE 1. Also, in the embodiment, basically, the UE 1 cannot serve as a relay unless having been activated, but once activated, may serve as a relay. Thus, basically, the UE 1 after having been activated will be referred to as a relay candidate, and a UE selected as the relay by the remote UE will be referred to as the relay UE.

At Step S10, the eNB 10 activates the UE 1. A UE serving as the relay between the remote UE 2 and the eNB 10 is selected among relay candidate UEs having been activated.

At Step S20, an indication of relay-enabled NW/UE is made by the relay candidate UE 1 to the remote UE 2. By these indications, the remote UE 2 can grasp that UEs enabled for relay operations exist in the network (the eNB 10) supporting the relay. The indication is done by, for example, the PSSS/SSSS, PSBCH, and PSDCH. At Step S30, a relay UE is selected among the relay candidate UEs. When selecting the relay UE, for example, a request is transmitted from the remote UE 2 to the relay candidate UE 1, then, based on the request, a signal (measurement resource) is transmitted from the relay candidate UE 1 to the remote UE 2, and the remote UE 2 executes quality measurement of the signal transmitted by the measurement resource, to select a UE to serve as the relay UE. In the following, the term “measurement resource” may be used for meaning a signal transmitted by the resource.

Then, at Step S40, a connection process is executed on the upper layers, and at Step S50, relay communication is executed. In the following, an example of Steps S10-S30 will be described in detail.

(Activating UE)

Not all UEs in the coverage are suitable for the D2D relay for expanding the NW coverage. Therefore, in the embodiment, only suitable UEs in the coverage are activated to operate as relay candidate UEs.

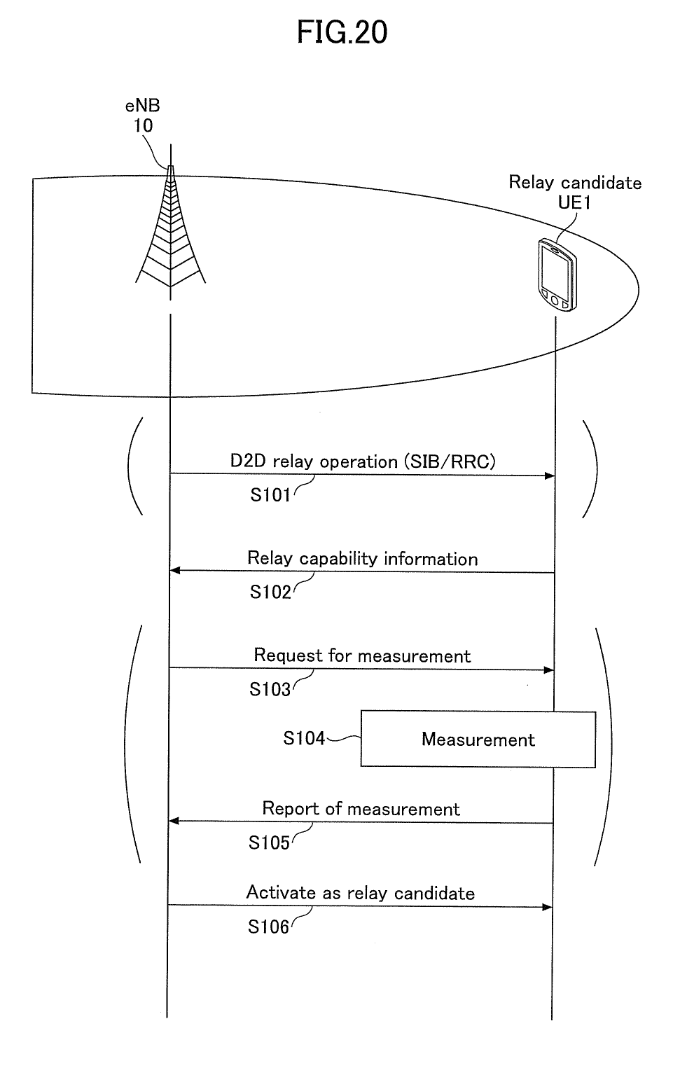

With reference to FIG. 20, an example of steps for activating a UE will be described. In this example of steps, the eNB 10 determines a UE to be a relay candidate based on UE capability and a measurement report, and activates the UE. However, in FIG. 20, steps in parentheses are optional, which do not need to be executed. In FIG. 20, only the UE 1 is designated as a UE, but it appears in the figure as a representative UE; the process is actually executed by selecting and activating the UE 1 among multiple UEs.

At Step S101, the eNB 10 indicates information representing a D2D relay operation (SIB, RRC, and the like). This signaling includes information representing that the network supports the relay, or information representing that a UE is requested to report the relay capability.

At Step 102, the UE 1 transmits the capability information about the D2D relay to the eNB 10. When indicating the system information at Step S101, the UE 1 can indicate the capability information about the D2D relay based on that it has received the system information (information representing that the network supports the relay).

At Step S103, the eNB 10 makes a request for measurement to the UE 1. The request for measurement, for example, may be executed with an RRC signal, or may be executed with a MAC signal. The UE 1 executes measurement based on the request for measurement (Step S104). At Step S104, the UE 1, measures reception power/reception quality (RSRP/RSRQ) and the like in the cellular, and measures signals transmitted by other activated relay candidate UEs (e.g., DM-RS in the PSDCH, PSCCH, PSSCH, and the like) to detect activated relay candidate UEs in the neighborhood.

The result of the measurement at Step S104 is reported as a measurement report from the UE 1 to the eNB 10. The measurement report includes, for example, the reception power/reception quality (RSRP/RSRQ) of the backhaul link, the number of relay candidate UEs and/or the reception levels and the like of the relay candidate UEs that exist in the neighborhood of the UE 1 and have a reception level over a certain level.

The eNB 10 determines UEs to be activated as relay candidates, based on the measurement reports and the UE capability information received from UEs including the UE 1, and activates the determined UEs (Step S106).

For example, the eNB 10 determines a UE to be activated as a relay candidate, from the reception power/reception quality, that has the quality appropriate for the backhaul link, and has other relay candidate UEs existing in the neighborhood where the number of the others is less than or equal to a threshold determined in advance.

The measurement at Step 104 and the measurement report at Step 105 may be done by a relay candidate UE having been activated, and based on the measurement report, the eNB 10 may deactivate the UE if the relay candidate UE once activated becomes unable to satisfy the condition to be activated.

Activation/deactivation of a UE can be executed by upper layer signaling from the eNB 10 to the UE. The signaling may use, for example, an RRC signal or a MAC signal. Also, at a timing of the signaling for activation or another timing (e.g., at Step S101), the eNB 10 may indicate the information about the resource for relay initialization to the UE 1. The information about the resource for relay initialization is, for example, information of the measurement resource to be transmitted to the remote UE in the relay initialization, information to be included in the PSBCH, and the like. Even if it is in RRC_ IDLE or DRX, it is considered that a relay request can be accepted, and hence, an active state may be maintained until a timer provided for the activation expires even if it transits into RRC_IDLE or DRX. Alternatively, the active state may be limited to RRC_CONNECTED to prevent a delay from occurring that may be caused when establishing an RRC connection for relay connection. These operations may be set to be switched by signaling from eNB, or one of these may be defined as a terminal operation.

Also, an activated remote candidate UE may deactivate itself autonomously, for example, if detecting a drop of the backhaul link quality, if the residual capacity of a terminal battery is decreased, or the like, and this may be reported to the eNB if an RRC connection is established.

It is possible not to execute Steps S103-S105. In this case, for example, the eNB 10 activates UEs among UEs having the relay capability so that a predetermined ratio of UEs become the relay candidate UEs.

(D2D Indication of Relay-Enabled NW/UE)

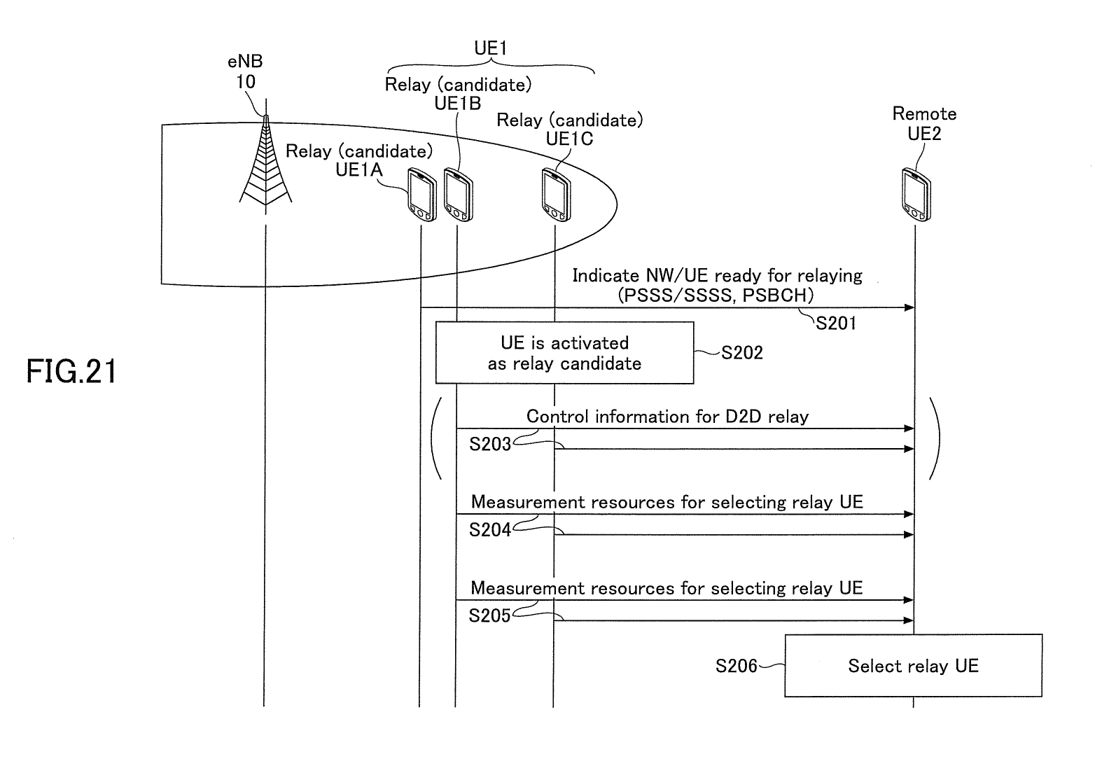

Next, a process will be described with reference to FIG. 21, including an indication of relay-enabled NW/UE representing that a UE is available for the D2D relay.

As illustrated in FIG. 21, the UE 1 transmits the PSSS/SSSS and PSBCH (Step S201). The remote UE 2 being outside the coverage executes timing synchronization and frequency synchronization with the UE 1 in the coverage by the PSSS/SSSS. Also, the remote UE 2 grasps the frame number (DFN) and the like by the PSBCH.

The PSBCH at Step S201 corresponds to the PSBCH including the information for receiving the D2D SIB previously described.

The PSBCH includes “In-coverage indicator” that represents whether the transmitting side is in the coverage or out of the coverage. In the embodiment, it is possible to assume that, for example, if the bit of the “In-coverage indicator” is a bit representing “in the coverage”, the UE 1 on the transmitting side is relay-enabled.

Also, the PSBCH includes “Reserved field” (e.g., 19 bits). For example, the UE 1 on the transmitting side being relay-enabled (having the capability of the relay, and the network supports the relay) may transmit the PSBCH having the information (bit) representing about being relay-enabled in “Reserved field” so that the remote UE 2 receiving the PSBCH determines that the relay-enabled UE 1 exists if the information about being relay-enabled is included in “Reserved field”. Also, when transmitting D2D relay specific control information described later, the configuration information about the resource pool that transmits the D2D relay specific control information (the remote UE 2 receives it) may be included in “Reserved field”.

In the embodiment, an indication of relay-enabled UE using the PSBCH is transmitted regardless whether the UE 1 is activated as a relay candidate or not activated. FIG. 21 illustrates that an indication of relay-enabled UE is transmitted by the UE 1 before activated. However, only activated UEs may transmit the indication of relay-enabled UE.

At Step S202, the UE 1B and the UE 10 are activated as relay candidates. In the following description in FIG. 21, the UE 1 denotes the UE 1B or the UE 10.

At Step S203, the UE 1 transmits (broadcasts) the D2D relay specific control information to the remote UE 2. The D2D relay specific control information corresponds to the previously described D2D SIB, and includes information for the remote UE 2 to receive or transmit a D2D channel (e.g., a measurement resource) used for selecting the relay UE. The configuration information for the D2D transmission and reception (resource pools and the like) to be used at Steps S40 and S50 in FIG. 19 may be also indicated. For example, the D2D relay specific control information is assumed to be transmitted periodically so that UE out of the coverage receives arbitrarily.

Since an indication of relay-enabled UE is possible by using the D2D SIB, the PSBCH may be used only for triggering the D2D SIB reception. If using the PSBCH for an indication of relay-enabled UE, and a UE out of the coverage cannot receive the D2D SIB, the UE out of the coverage may make a request for relay to the UE in the coverage by Relay Discovery of Model B by using a pre-configured parameter.

As already described, the D2D relay specific control information may be transmitted by the PSDCH using the fields of ProSe Application Code and the like in the PSDCH (discovery message). For example, limited variations of the resource pool for transmitting the PSDCH may be defined so that the number of required bits for indicating the configuration information can be reduced, and the configuration information (configuration) of the PSDCH resource can be indicated by the PSBCH at Step S201.

Also, for example, if the amount of information of the D2D relay specific control information is small, the D2D relay specific control information may be transmitted by using the PSBCH at Step S201. In this case, the transmission at Step S203 is unnecessary.

Then, from the UE 1 to the remote UE 2, a measurement resource for the relay UE selection is transmitted (Steps S204 and S205). The measurement resource corresponds to the information about the resource represented in the D2D relay specific control information transmitted at Step S202 and the like. The remote UE 2 having received the signal measures the reception quality (RSRP, RSRQ, and the like) of the signal received by the measurement resource, and selects, for example, a UE having the best reception quality as the relay UE (Step S206). Also, the measurement resource is transmitted, for example, by the PSDCH or PSCCH/PSSCH. As illustrated in FIG. 5 and the like, these channels are transmitted periodically.

As described with Step S104 in FIG. 20, a UE in the coverage detects activated relay candidates in the neighborhood. As the resource to monitor (measure) for this detection, for example, the DM-RS in channels of some periods can be used among the channels which the remote candidate UEs transmit periodically, at Steps S204, S205, and the like in FIG. 21.

The relay candidate UE 1 may prioritize the detection (the reception of the DM-RS) of relay candidate UEs in the neighborhood over the D2D transmission. However, the detection (the reception of the DM-RS) of relay candidate UEs in the neighborhood is not prioritized over the transmission of the PSSS/SSSS, PSBCH (and the D2D relay specific control information), and the measurement resource.

As already described, the D2D relay specific control information and/or the PSBCH includes configuration information and the like for the remote UE 2 to receive the D2D channel (measurement resource) used for the relay UE selection. More specifically, the D2D relay specific control information and/or the PSBCH includes, for example, a resource pool configuration, CP length information, and a DM-RS configuration as contents. The contents, are set to the UE 1 in the coverage, for example, from the eNB 10 by upper layer signaling. Therefore, a rel-12 UE can also transmit an indication of relay-enabled UE by using the PSBCH.

The D2D relay specific control information and/or the PSBCH may further include an operator ID (e.g., PLMN or APN). This makes it possible for the remote UE 2 to determine whether the network can be accessed in advance. By using an ID based on the operator ID as the destination ID, the operator ID may be indicated implicitly. Also, the D2D relay specific control information and/or the PSBCH may include an L2 group destination ID. This makes it possible for the remote UE 2 to transmit a request for relay to relay candidate UEs by a multicast having the group specified. Also, the D2D relay specific control information and/or the PSBCH may include security-related parameters such as a security key.

Note that the D2D relay specific control information as described above may be pre-configured in each UE so as not to be transmitted to the remote UE 2.

As described above, by having the activated UEs work as relay candidates and having the UE in the coverage transmits the indication of relay-enabled UE to the remote UE, wasteful processes can be reduced, and relay communication can be started effectively.

Note that, the “remote UE” described above is for example, a UE out of coverage that cannot receive a synchronization signal or broadcast information from the base station, a UE that uses a synchronization signal transmitted by a terminal as the synchronizing source, a UE that cannot be connected to the network due to being unable to complete an RRC connection, or the like. In other words, the remote UE is not limited to a UE out of the coverage. Also, the UE “to serve as the relay UE” means, for example, a UE authenticated as the relay UE, a UE commanded by the base station to execute the operation as the relay UE, or the UE that determines whether to execute the relay operation autonomously and executes the operation necessary for the relay.

(Example of Configuration of User Apparatus)

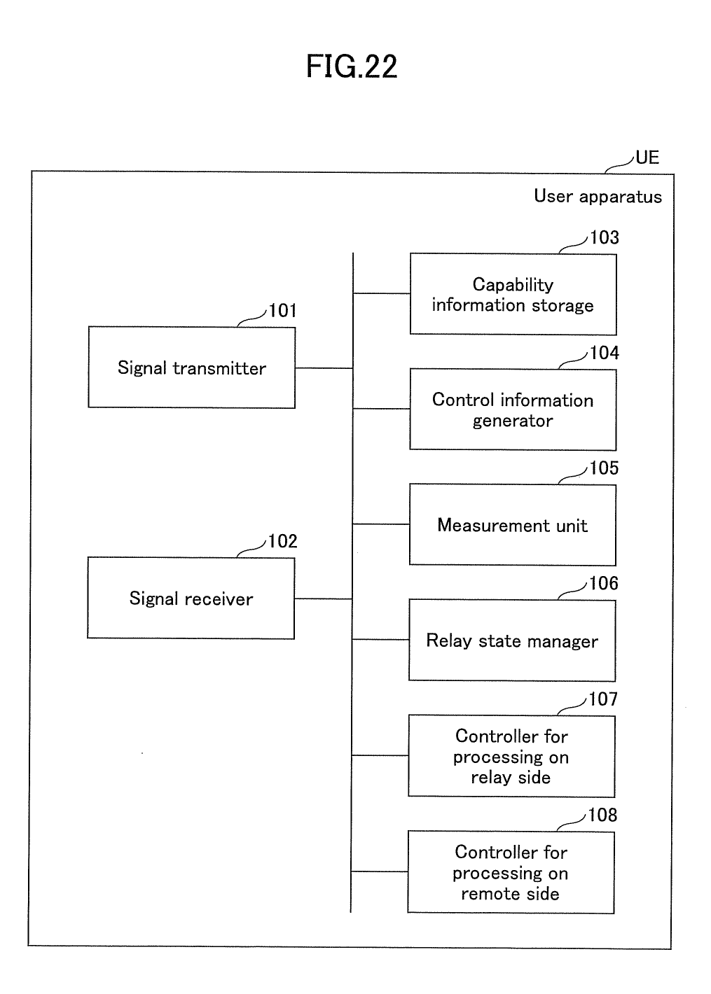

FIG. 22 illustrates a functional configuration diagram of a UE according to the embodiment. The UE illustrated in FIG. 22, may become either of a UE in the coverage or a UE out of the coverage described in the embodiment, but for example, may only include functions of a UE in the coverage, or may only include functions of a UE out of the coverage. Also, the example illustrated in FIG. 22 includes functions for the relay, but this is just an example, and it may be configured not to include the functions for the relay.

As illustrated in FIG. 22, the UE includes a signal transmitter 101, a signal receiver 102, a capability information storage 103, a control information generator 104, a measurement unit 105, a relay state manager 106, a controller for processing on relay side 107, and a controller for processing on remote side 108. Note that FIG. 22 only illustrates functional parts in the user apparatus UE particularly relating to the embodiment of the present invention; the user apparatus UE may also include functions not illustrated at least for executing operations compatible with LTE. Also, the functional configuration illustrated in FIG. 22 is just an example. Functional partitioning and names of the functional parts may be determined discretionarily as long as operations of UE can be executed according to the embodiment.

The signal transmitter 101 includes a function to generate various signals on the physical layer from a signal on a higher layer to be transmitted from the UE, and to wirelessly transmit the signals. The signal transmitter 101 also includes a function to transmit by D2D communication and a function to transmit by cellular communication.

The signal receiver 102 includes a function to wirelessly receive various signals from another UE or the eNB, and to obtain a signal on a higher layer from the received signals on the physical layer. The signal receiver 102 also includes a function to receive by D2D communication and a function to receive by cellular communication.

The capability information storage 103 stores capability information including information representing whether the UE has the capability to serve as the relay UE, and can transmit the capability information from the signal transmitter 101 to the eNB.

The control information generator 104 includes a function to generate information to be included in the PSBCH, the D2D SIB (D2D control information), and the like described in the embodiment, and to transmit the generated information through the signal transmitter 101. These information items may be generated, for example, based on information received from the eNB by signaling. The control information generator 104 and the signal transmitter 101 constitute a broadcast channel information transmitter to transmit the configuration information about the resources for a user apparatus out of the coverage located, for example, outside the coverage of the base station, to receive the D2D control information, and the information representing that the D2D control information is to be transmitted, by using a broadcast channel for D2D, and a control information transmitter to transmit in the D2D control information by using the resources.

The measurement unit 105 includes a function to measure a receiving signal (e.g., a DM-RS) for obtaining information of the reception quality (RSRP, RSRQ, and the like). The measurement unit 105 includes a function to execute both the measurement in the remote UE and the measurement in the relay (candidate) UE described in the embodiment. Also, the measurement is possible for both of the measurement of the access link and the measurement of the backhaul link.

Also, the measurement unit 105 includes a function to measure a signal from an activated UE in the neighborhood for detecting the activated UE in the neighborhood.

The relay state manager 106 manages (stores) information whether the UE is activated as a relay candidate or not. For example, when receiving an activation command from the eNB, the UE stores the information representing the activation. This corresponds to activating the UE, and the UE having been activated executes operations as a relay candidate such as transmission of the measurement resource, reception of the reply, and the like. Also, the relay state manager 105 also includes a function to deactivate the UE if a predetermined condition (e.g., the quality of the backhaul link) to continue to be activated becomes not satisfied.

The controller for processing on relay side 107 executes the relay process of data communication and controls operations of the UE serving on the relaying side as described above. For example, the controller for processing on relay side 107 executes transmission of an indication of relay-enabled UE, transmission of measurement resources and the like, transmission of the D2D relay specific control information, and the like through the signal transmitter 101. Also, it also includes a function to obtain an address from the PDN and to return information about the address in response to a request from the remote UE.

The controller for processing on remote side 108 controls operations of the UE on the side serving as the remote UE described above.

The configuration of the user apparatus UE illustrated in FIG. 22 may be implemented as a whole by a hardware circuit (e.g., one or more IC chips) or may be implemented partly by a hardware circuit, and by a CPU and a program for the other part.

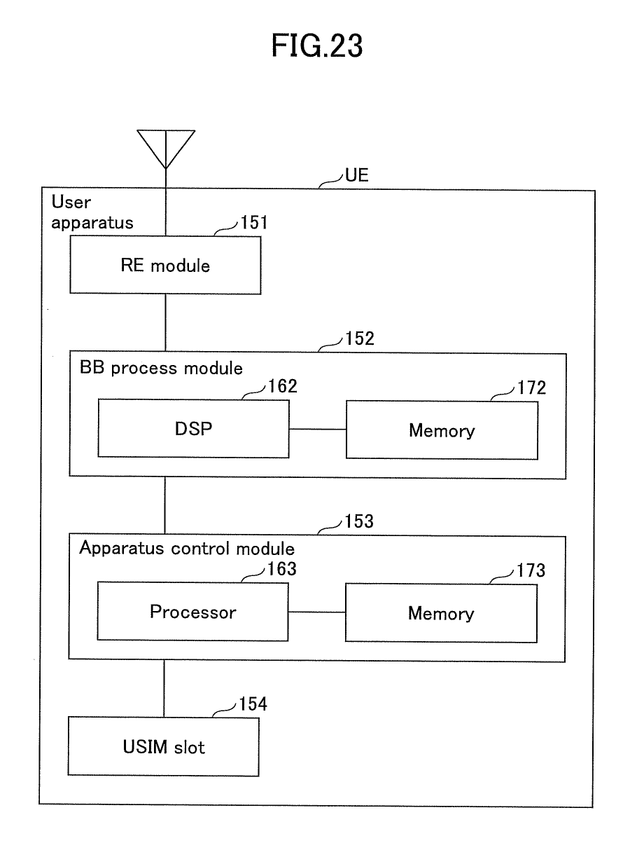

FIG. 23 is a diagram illustrating an example of a hardware (HW) configuration of the user apparatus UE. FIG. 23 illustrates a configuration that is closer to an actual physical implementation than in FIG. 22. As illustrated in FIG. 23, the UE includes an RE (Radio Equipment) module 151 to execute a process for a radio signal, a BB (baseband) process module 152 to execute baseband signal processing, a apparatus control module 153 to execute a process about upper layers and the like, and a USIM slot 154 to serve as an interface to access a USIM card.

The RE module 151 applies D/A (Digital-to-Analog) conversion, modulation, frequency conversion, and power amplification, and the like to a digital baseband signal received from the BB process module 152, to generate a wireless signal to be transmitted from the antenna. Also, it applies frequency conversion, A/D (Analog to Digital) conversion, demodulation, and the like to a received wireless signal, to generate a digital baseband signal, and to transfer the signal to the BB process module 152. The RE module 151 includes, for example, functions on physical layers and the like in the signal transmitter 101 and the signal receiver 102 in FIG. 22.

The BB process module 152 executes a process to mutually convert an IP packet and a digital baseband signal. A DSP (Digital Signal Processor) 162 is a processor to execute signal processing in the BB process module 152. A memory 172 is used as a work area of the DSP 162. The BB process module 152 includes, for example, functions on Layer 2 and the like in the signal transmitter 101 and the signal receiver 102, the capability information storage 103, the control information generator 104, the measurement unit 105, the relay state manager 106, the controller for processing on relay side 107, and the controller for processing on remote side 108 in FIG. 22. Note that all or a part of the functions of the capability information storage 103, the control information generator 104, the measurement unit 105, the relay state manager 106, the controller for processing on relay side 107, and the controller for processing on remote side 108 may be included in the apparatus control module 153.

The apparatus control module 153 executes protocol processing on the IP layer, processes of various applications, and the like. A processor 163 is a processor to execute processes to be executed by the apparatus control module 153. A memory 173 is used as a work area of the processor 163. The processor 163 also executes reads and writes of data with a USIM via the USIM slot 154.

(Example of Configuration of Base Station eNB)

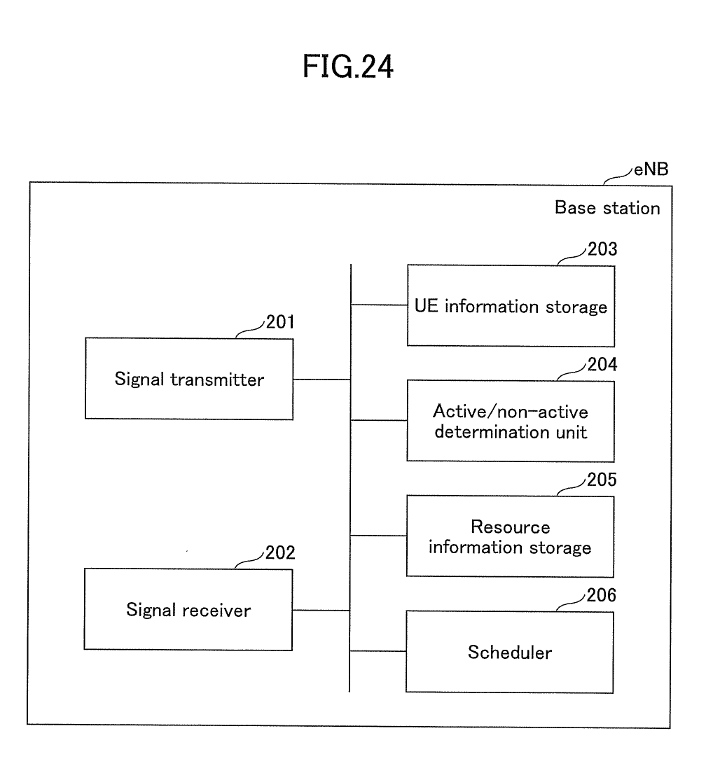

FIG. 24 illustrates a functional configuration diagram of the eNB according to the embodiment. As illustrated in FIG. 24, the eNB includes a signal transmitter 201, a signal receiver 202, a UE information storage 203, an active/non-active determination unit 204, a resource information storage 205, and a scheduler 206. Note that FIG. 24 only illustrates functional parts in the eNB particularly relating to the embodiment of the present invention; the eNB may also include functions not illustrated at least for operating as a base station in a mobile communication system compatible with LTE. Also, the functional configuration illustrated in FIG. 24 is just an example. Functional partitioning and names of the functional parts may be determined discretionarily as long as operations can be executed according to the embodiment.

The signal transmitter 201 includes a function to generate various signals on the physical layer from a signal on a higher layer to be transmitted from the eNB, and to wirelessly transmit the signals. The signal receiver 202 includes a function to wirelessly receive various signals from a UE for obtaining signals on higher layers from the received signal on the physical layers.

The UE information storage 203 stores information about the UE capability to receive from each UE, measurement reports, information about a state of activation or deactivation and the like for each of the UEs. The active/non-active determination unit 204 includes a function to determine activation/deactivation of a UE, and to indicate an activation command and the like to the UE, based on information stored in the UE information storage 203.

The resource information storage 205 stores information representing allocated D2D resources and the like for each of the UEs. Also, when the resources are released, the allocation information is deleted. The scheduler 206 includes a function to execute the resource allocation. The scheduler 206 also includes a function for the relay UE to determine the configuration information about the resource to be included in the PSBCH, the D2D relay specific control information, and the like and to indicate the information to a UE through the signal transmitter 201.

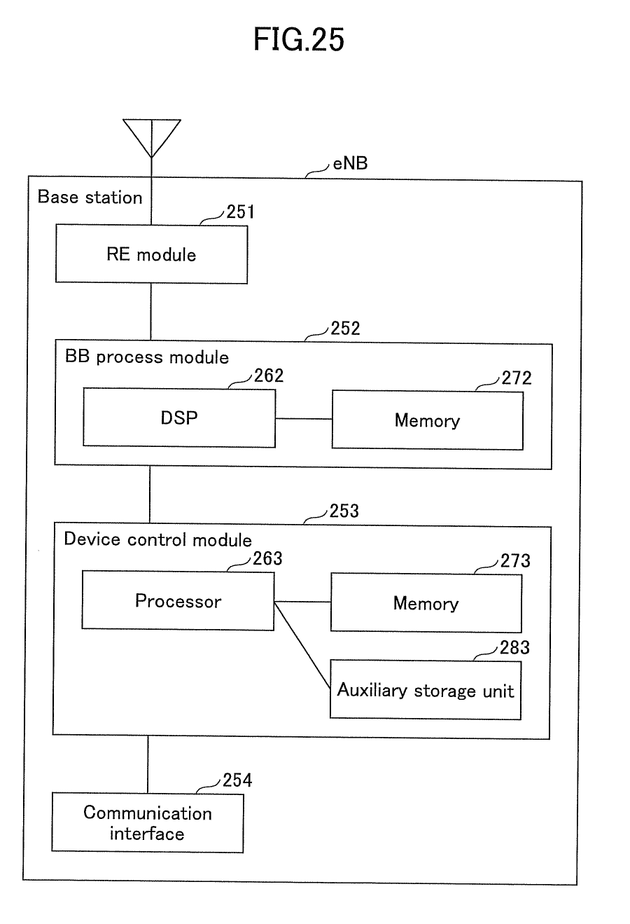

The configuration of the base station eNB illustrated in FIG. 25 may be implemented as a whole by a hardware circuit (e.g., one or more IC chips) or may be implemented partly by a hardware circuit, and by a CPU and a program for the other part.

FIG. 25 is a diagram illustrating an example of a hardware (HW) configuration of the base station eNB. FIG. 25 illustrates a configuration that is closer to an actual physical implementation than in FIG. 24. As illustrated in FIG. 25, the base station eNB includes an RE module 251 to execute a process for a wireless signal, a BB process module 252 to execute baseband signal processing, a apparatus control module 253 to execute a process on upper layers and the like, and a communication IF 254 to serve as an interface to make a connection to the network.

The RE module 251 applies D/A conversion, modulation, frequency conversion, and power amplification, and the like to a digital baseband signal received from the BB process module 252, to generate a wireless signal to be transmitted from the antenna. Also, it applies frequency conversion, A/D conversion, demodulation, and the like to a received wireless signal, to generate a digital baseband signal, and to transfer the signal to the BB process module 252. The RE module 251 includes, for example, functions on physical layers and the like in the signal transmitter 201 and the signal receiver 202 in FIG. 24.

The BB process module 252 executes a process to mutually convert an IP packet and a digital baseband signal. A DSP 262 is a processor to execute signal processing in the BB process module 252. A memory 272 is used as a work area of the DSP 262. The BB process module 252 includes, for example, functions on Layer 2 and the like in the signal transmitter 201 and the signal receiver 202 the UE information storage 203, the active/non-active determination unit 204, the resource information storage 205, and the scheduler 206 in FIG. 24. Note that all or a part of the functions of the UE information storage 203, the active/non-active determination unit 204, the resource information storage 205, and the scheduler 206 may be included in the apparatus control module 253.

The apparatus control module 253 executes protocol processing on the IP layer, OAM processes, and the like. A processor 263 is a processor to execute processes to be executed by the apparatus control module 253. A memory 273 is used as a work area of the processor 263. An auxiliary storage unit 283 is, for example, an HDD or the like, to store various setting information items and the like for the base station eNB to operate itself.

By the embodiments described so far, a user apparatus used in a mobile communication system supporting D2D communication is provided that includes a broadcast channel information transmitter configured to transmit configuration information about a resource for another user apparatus to receive D2D control information, and information representing that the D2D control information is to be transmitted by using a broadcast channel for D2D; and a control information transmitter configured to transmit the D2D control information by using the resource.

Configured as described above, it is possible to effectively transmit and receive control information between user apparatuses in D2D communication.

The broadcast channel information transmitter may further transmit a change notification representing that a change has occurred in the D2D control information. This makes it possible for a user apparatus out of the coverage to grasp the change of the D2D control information.

A receiver may be included that is configured to receive the information to be transmitted by using the broadcast channel for D2D, from a base station. This configuration makes it possible for the user apparatus to transmit appropriate information by a broadcast channel.

The control information transmitter may transmit the D2D control information by using a channel for discovery, wherein the configuration information about the resource is configuration information about a resource pool having one or more parameters fixed among the parameters to specify the resource pool of the channel for discovery. This configuration makes it possible to make the amount of information to be transmitted in the broadcast channel smaller.

The control information transmitter may transmit the D2D control information by using a format in which a message type of a discovery message to be transmitted by a channel for discovery is set to a message type representing the D2D control information. This configuration makes it possible to use a discovery message effectively for transmitting the D2D control information.

For example, the D2D control information is control information specific to the user apparatus, or control information common to the user apparatuses. In a case where the D2D control information is the control information specific to the user apparatus, the D2D control information may include the ID of Layer 2 or Layer 3 of the user apparatus. This makes it possible on the side that received the D2D control information to grasp the transmission source appropriately.

The user apparatus may have the capability to serve as a relay apparatus relaying data communication between the other user apparatus and a base station, and the D2D control information may include configuration information of a resource to be used in the other user apparatus for selecting a relay apparatus among candidates of the relay apparatus. This configuration makes it possible to effectively implement relay communication to relay data communication between the user apparatus out of the coverage and the base station.

The user apparatus UE described in the embodiments may be configured to include a CPU and a memory, and to be realized by executing a program by the CPU (processor), or may be realized by hardware such as hardware circuits including the processing logic described in the embodiments, or may be configured to have a program and hardware coexist.

The base station eNB described in the embodiments may be configured to include a CPU and a memory, and to be realized by executing a program by the CPU (processor), or may be realized by hardware such as hardware circuits including the processing logic described in the embodiments, or may be configured to have a program and hardware coexist.

So far, the embodiments of the present invention have been described, but the disclosed invention is not limited to the embodiments, those skilled in the art may conceive of various transformed examples, modified examples, alternative examples, substituted examples, and the like. To facilitate understanding of the present invention, specific numerical values have been used as examples in the description, note that such numerical values are just examples, and any appropriate values may be used unless specified otherwise. Partitioning of items in the above description is not essential in the present invention, features described in two or more items may be combined and used if necessary, and a feature described in an item may be applied to another feature described in another item unless introducing contradiction. The boundaries of the functional units or the processing units in the functional block diagram do not necessarily correspond to the boundaries of physical components. The operations by multiple functional units may be executed by a physically single component, alternatively, the operations by a single functional unit may be executed by physically multiple components. For the sake of explanation, user apparatus UE and base station eNB have been described by using the functional block diagrams, however, such apparatuses may be implemented in hardware, software, or a combination of those. The software running on a processor of the user apparatus UE and the software running on a processor of the base station eNB according to an embodiment of the present invention, may be stored in any proper storage medium such as a Random Access Memory (RAM), a flash memory, a Read-Only Memory (ROM), an EPROM, an EEPROM, a register, a hard disk (HDD), a removable disk, a CD-ROM, a database, and a server.

The present invention is not limited to the above embodiments and includes various transformed examples, modified examples, alternative examples, and substituted examples without departing from the spirit of the present invention.

The present patent application claims priority based on Japanese patent application No. 2015-74184, filed on Mar. 31, 2015, and the entire contents of the Japanese patent application No. 2015-74184 are incorporated herein by reference.

### DESCRIPTION OF REFERENCE SIGNS

eNB base station
UE user apparatus
101 signal transmitter
102 signal receiver
103 capability information storage
104 control information generator
105 measurement unit
106 relay state manager
107 controller for processing on relay side
108 controller for processing on remote side
151 RE module
152 BB process module
153 apparatus control module
154 USIM slot
201 signal transmitter
202 signal receiver
203 UE information storage
204 active/non-active determination unit
205 resource information storage
206 scheduler
251 RE module
252 BB process module
253 apparatus control module
254 communication IF

1. A user apparatus used in a mobile communication system supporting D2D communication, the user apparatus comprising:
a broadcast channel information transmitter configured to transmit configuration information of a resource for another user apparatus to receive D2D control information, and information representing that the D2D control information is to be transmitted by using a broadcast channel for D2D; and
a control information transmitter configured to transmit the D2D control information by using the resource.

2. The user apparatus as claimed in claim 1, wherein the broadcast channel information transmitter further transmits a change notification representing that a change has occurred in the D2D control information.

3. The user apparatus as claimed in claim 1, further comprising:
a receiver configured to receive the information to be transmitted by using the broadcast channel for D2D, from a base station.

4. The user apparatus as claimed in claim 1, wherein the control information transmitter transmits the D2D control information by using a channel for discovery,
wherein the configuration information of the resource is configuration information of a resource pool having one or more parameters fixed among the parameters to specify the resource pool of the channel for discovery.

5. The user apparatus as claimed in claim 1, wherein the control information transmitter transmits the D2D control information by using a format in which a message type of a message for discovery to be transmitted by a channel for discovery is set to a message type representing the D2D control information.

6. The user apparatus as claimed in claim 1, wherein the D2D control information is control information specific to the user apparatus, or control information common to the user apparatuses.

7. The user apparatus as claimed in claim 6, wherein in a case where the D2D control information is the control information specific to the user apparatus, the D2D control information includes an ID of Layer 2 or Layer 3 of the user apparatus.

8. The user apparatus as claimed in claim 1, wherein the user apparatus has capability to serve as a relay apparatus relaying data communication between the other user apparatus and a base station,
wherein the D2D control information includes configuration information of a resource to be used in the other user apparatus for selecting a relay apparatus among candidates of the relay apparatus.

9. A method for transmitting control information, executed by a user apparatus used in a mobile communication system supporting D2D communication, the method comprising:
a step of transmitting broadcast channel information for transmitting configuration information of a resource for another user apparatus to receive D2D control information, and information representing that the D2D control information is to be transmitted by using a broadcast channel for D2D; and
a step of transmitting control information for transmitting the D2D control information by using the resource.

10. The user apparatus as claimed in claim 2, further comprising:
a receiver configured to receive the information to be transmitted by using the broadcast channel for D2D, from a base station.

11. The user apparatus as claimed in claim 2, wherein the control information transmitter transmits the D2D control information by using a channel for discovery,
wherein the configuration information of the resource is configuration information of a resource pool having one or more parameters fixed among the parameters to specify the resource pool of the channel for discovery.

12. The user apparatus as claimed in claim 3, wherein the control information transmitter transmits the D2D control information by using a channel for discovery,
wherein the configuration information of the resource is configuration information of a resource pool having one or more parameters fixed among the parameters to specify the resource pool of the channel for discovery.

13. The user apparatus as claimed in claim 2, wherein the control information transmitter transmits the D2D control information by using a format in which a message type of a message for discovery to be transmitted by a channel for discovery is set to a message type representing the D2D control information.

14. The user apparatus as claimed in claim 3, wherein the control information transmitter transmits the D2D control information by using a format in which a message type of a message for discovery to be transmitted by a channel for discovery is set to a message type representing the D2D control information.

15. The user apparatus as claimed in claim 4, wherein the control information transmitter transmits the D2D control information by using a format in which a message type of a message for discovery to be transmitted by a channel for discovery is set to a message type representing the D2D control information.

16. The user apparatus as claimed in claim 2, wherein the D2D control information is control information specific to the user apparatus, or control information common to the user apparatuses.

17. The user apparatus as claimed in claim 3, wherein the D2D control information is control information specific to the user apparatus, or control information common to the user apparatuses.

18. The user apparatus as claimed in claim 2, wherein the user apparatus has capability to serve as a relay apparatus relaying data communication between the other user apparatus and a base station,
wherein the D2D control information includes configuration information of a resource to be used in the other user apparatus for selecting a relay apparatus among candidates of the relay apparatus.

19. The user apparatus as claimed in claim 3, wherein the user apparatus has capability to serve as a relay apparatus relaying data communication between the other user apparatus and a base station,
wherein the D2D control information includes configuration information of a resource to be used in the other user apparatus for selecting a relay apparatus among candidates of the relay apparatus.
